(19) United States
(12) Patent Application Publication
(10) Pub. No.: US 2026/0101255 A1
(43) Pub. Date: Apr. 9, 2026

(54) METHOD AND SYSTEM FOR HANDLING PING-PONG HANDOVER EVENT BETWEEN A PLURALITY OF ACCESS POINTS

(71) Applicant: Samsung Electronics Co., Ltd., Suwon-si (KR)

(72) Inventors: Manasi EKKUNDI, Bengaluru (IN); Karthik Srinivasa GOPALAN, Bengaluru (IN); Abhishek CHATURVEDI, Bengaluru (IN)

(21) Appl. No.: 19/415,165

(22) Filed: Dec. 10, 2025

Related U.S. Application Data
(63) Continuation of application No. PCT/KR2025/013336, filed on Sep. 1, 2025.

(30) Foreign Application Priority Data
Sep. 3, 2024 (IN) 202441066604
Aug. 28, 2025 (IN) 202441066604

(51) Int. Cl. H04W 36/08; H04W 60/04; H04W 76/10

(52) U.S. Cl. CPC H04W 36/08; H04W 60/04; H04W 76/10

(57) ABSTRACT

A method for handling a ping-pong handover event between a plurality of Access Points (APs) in a wireless communication network includes detecting an occurrence of a number of ping-pong handover events between a first AP and a second AP; determining whether the number of ping-pong handover events between the first AP and the second AP exceeds a predefined threshold value; transmitting a re-association request to the second AP, wherein re-association request comprises an indication of a required service type for the electronic device and a flag indicating a requirement for assistance for the electronic device; and receiving station (STA) assistance information from the second AP to manage the required service type for the electronic device.

### CROSS-REFERENCE TO RELATED APPLICATIONS

This application is a continuation of International Application No. PCT/KR2025/013336 designating the United States, filed on Sep. 1, 2025, in the Korean Intellectual Property Receiving Office and claiming priority to Indian Provisional Patent Application No. 202441066604, filed on Sep. 3, 2024, and Indian Complete patent application No. 202441066604, filed on Aug. 28, 2025, the disclosures of each of which are incorporated by reference herein in their entireties.

### BACKGROUND

### Field

The disclosure relates to the wireless communication networks, and for example, to a method and a system for handling a handover event between a plurality of Access Points (APs) in the wireless communication network.

### Description of Related Art

In the context of wireless communication systems, Institute of Electrical and Electronics Engineers (IEEE) 802.11 Ultra High Reliability (UHR) is a wireless communication standard designed to enhance the reliability and performance of Wireless-Fidelity (Wi-Fi) networks. The IEEE 802.11 UHR aims to support critical applications that require consistent and stable connectivity. For instance, consider a typical home environment where various IEEE 802.11-enabled devices coexist with a Wi-Fi device 100 (known as, Access Point (AP)), as illustrated in FIG. 1, including appliances like TVs, air conditioners, microwaves, refrigerators, and smart light bulbs. Family members also use multiple devices such as smartphones, tablets, laptops, wearables, Augmented Reality (AR)/Virtual Reality (VR)/Extended Reality (XR) devices, and power-data-hungry gaming setups. Additionally, the home environment may feature Internet of Things (IOT) devices with smart sensors connecting over 802.11 networks. In denser ecosystems/environments, like apartment complexes, offices, malls, and airports, many users share the same network. Industrial settings also require reliable 802.11 connectivity for various functions, instruments, and requirements. The diverse ecosystem includes devices with different performance requirements.

For instance, IoT sensors typically require low latency and power, while laptops and TVs need high throughput for tasks like streaming and gaming. XR devices demand high throughput, reliability, low latency, and mobility. To accommodate these varying needs, the current 802.11 standard defines certain traffic and access categories for both non-Access Point (AP)/Station (STA) clients and APs. However, several problems are encountered in the existing IEEE 802.11 UHR, which are mentioned below.

A significant issue/problem arises with a ping-pong roaming (ping-pong handover event) in the current IEEE 802.11 UHR standard. This problem can be illustrated through a typical scenario(s) (201 and 202), as illustrated in FIGS. 2A and 2B. In environments such as homes, offices, malls, or outdoor spaces, multiple APs (e.g., AP1 100a, AP2 100b, etc.) are deployed to enhance coverage and service for various connected devices (e.g., XR, watch, mobile handset, tablet, laptop, etc.). In this scenario(s) (201 and 202), factors such as human (user) obstruction and temporary blockages can cause the signal strength of the currently connected AP (e.g., AP1 100a) to drop below acceptable levels, prompting a station (STA) (e.g., XR, watch, mobile handset, tablet, laptop, etc.) to roam and connect to another AP (e.g., AP2 100b). Once the blockages are cleared, the signal strength of the original AP (e.g., AP1 100a) may improve, allowing the STA to reassociate with the original AP (e.g., AP1 100a). This process can happen repeatedly in crowded areas or locations with obstacles between the AP(s) (e.g., AP1 100a, AP2 100b, etc.) and the STA (e.g., XR, watch, mobile handset, tablet, laptop, etc.), leading to frequent switching between APs (e.g., AP1 100a, AP2 100b, etc.).

These repeated transitions, known as ping pongs, can result in an unreliable user experience. The STA must scan for new APs, reassociate, and resume operations. Frequent ping pongs disrupt data services, negatively impact throughput performance, hinder power-saving efforts, and lead to suboptimal negative airtime resources, as described in conjunction with FIGS. 3A, 3B and 4.

Thus, it is desired to address the above-mentioned disadvantages or other shortcomings, or at least provide a useful alternative for handling the ping-pong handover event between a plurality of APs in the wireless communication network.

The description set forth in the background section should not be assumed to be prior art merely because it is set forth in the background section.

### SUMMARY

According to an example embodiment of the present disclosure, a method for handling a ping-pong handover event between a plurality of Access Points (APs) in a wireless communication network is provided. The method includes: detecting, by an electronic device, an occurrence of a number of ping-pong handover events between a first AP among the plurality of APs and a second AP among the plurality of APs; determining, by the electronic device, whether the number of ping-pong handover events between the first AP and the second AP exceeds a defined threshold value; transmitting, by the electronic device, a re-association request to the second AP, wherein the electronic device is previously connected with the first AP, in response to determining that the number of the ping-pong handover events between the first AP and the second AP exceeds the defined threshold value, wherein re-association request comprises an indication of a required service type for the electronic device and a flag indicating a requirement for assistance for the electronic device; and receiving, by the electronic device, station (STA) assistance information from the second AP to manage the required service type for the electronic device in response to transmitting the re-association request.

According to an example embodiment of the present disclosure, a method for handling a ping-pong handover event between a plurality of Access Points (APs) in a wireless communication network is disclosed. The method includes: receiving, by a second AP among the plurality of APs, a re-association request from an electronic device, wherein the electronic device is previously connected with a first AP among the plurality of APs, and the electronic device detects that a number of ping-pong handover events between the first AP and the second AP exceeds a defined threshold value. The re-association request comprises an indication of a required service type for the electronic device and a flag indicating a requirement for assistance for the electronic device. The method further includes generating, by the second AP, a recommendation based on the received association request; and transmitting, by the second AP, Station (STA) assistance information to the electronic device to manage the required service type for the electronic device, wherein the STA assistance information comprises the generated recommendation.

According to an example embodiment of the present disclosure, a method for handling a ping-pong handover event between a plurality of Access Points (APs) in a wireless communication network is disclosed. The method includes: detecting, by an electronic device, an occurrence of a number of ping-pong handover events between a first AP among the plurality of APs and a second AP among the plurality of APs; determining, by the electronic device, whether the number of ping-pong handover events between the first AP and the second AP exceeds a defined threshold value; triggering, by the electronic device, a service type event in the electronic device in response to determining that the number of the ping-pong handover events between the first AP and the second AP exceeds the defined threshold value, wherein the service type event comprises at least one of a power saving event, a throughput event, a latency event, or a reliability event; transmitting, by the electronic device, a Station (STA) assistance request to the second AP, wherein the electronic device is prior connected with the first AP in response to triggering the service type event, wherein the STA assistance request comprises an indication of a service type event required for the electronic device and a ping-pong flag indicating a requirement for assistance for the electronic device; and receiving, by the electronic device, a STA assistance response from the second AP to manage the service type event required for the electronic device in response to transmitting the STA assistance request.

According to an example embodiment of the present disclosure, a method for handling a ping-pong handover event between a plurality of Access Points (APs) in a wireless communication network is disclosed. The method includes: receiving, by a second AP among the plurality of APs, a Station (STA) assistance request from an electronic device, wherein the electronic device is prior connected with the first AP, and a service type event is triggered at the electronic device due to a number of ping-pong handover events between the first AP and the second AP exceeding a defined threshold value. The STA assistance request comprises an indication of a service type event required for the electronic device, and a ping-pong flag indicating a requirement for assistance for the electronic device. The method further includes: generating, by the second AP, a recommendation based on the received STA assistance request; and transmitting, by the second AP, a STA assistance response to the electronic device to manage the service type event required for the electronic device, wherein the STA assistance response comprises the generated recommendation.

According to an example embodiment of the present disclosure, an electronic device for handling a ping-pong handover event between a plurality of Access Points (APs) in a wireless communication network is disclosed. The electronic device includes a system, the system comprising: a ping-pong handover event management module, comprising circuitry, coupled with a memory, at least one processor, comprising processing circuitry, and a communicator comprising communication circuitry. The ping-pong handover event management module may be included in at least one processor or implemented by at least one processor. The ping-pong handover event management module is configured to: detect an occurrence of a number of ping-pong handover events between a first AP among the plurality of APs and a second AP among the plurality of APs; determine whether the number of ping-pong handover events between the first AP and the second AP exceeds a defined threshold value; transmit a re-association request to the second AP, wherein the electronic device is previously connected with the first AP, in response to determining that the number of the ping-pong handover events between the first AP and the second AP exceeds the defined threshold value, wherein the re-association request comprises an indication of a required service type for the electronic device and a flag indicating a requirement for assistance for the electronic device; and receive Station (STA) assistance information from the second AP to manage the required service type for the electronic device in response to transmitting the re-association request.

According to an example embodiment of the present disclosure, an electronic device for handling a ping-pong handover event between a plurality of Access Points (APs) in a wireless communication network is disclosed. The electronic device includes a system, the system includes a ping-pong handover event management module comprising circuitry coupled with a memory, at least one processor, comprising processing circuitry, and a communicator comprising communication circuitry. The ping-pong handover event management module may be included in at least one processor or implemented by at least one processor. The ping-pong handover event management module is configured to: detect an occurrence of a number of ping-pong handover events between a first AP among the plurality of APs and a second AP among the plurality of APs; determine whether the number of ping-pong handover events between the first AP and the second AP exceeds a defined threshold value; trigger a service type event in the electronic device in response to determining that the number of the ping-pong handover events between the first AP and the second AP exceeds the defined threshold value, wherein the service type event comprises at least one of a power saving event, a throughput event, a latency event, a reliability event; transmit a Station (STA) assistance request to the second AP, wherein the electronic device is prior connected with the first AP in response to triggering the service type event, wherein the STA assistance request comprises an indication of a service type event required for the electronic device and a ping-pong flag indicating a requirement for assistance for the electronic device; and receive a STA assistance response from the second AP to manage the service type event required for the electronic device in response to transmitting the STA assistance request.

According to an example embodiment of the present disclosure, an Access Point (AP) for handling a ping-pong handover event between a plurality of APs in a wireless communication network is disclosed. The AP includes a system, the system includes a ping-pong handover event management module comprising circuitry coupled with a memory, at least one processor, comprising processing circuitry, and a communicator comprising communication circuitry. The ping-pong handover event management module may be included in at least one processor or implemented by at least one processor. The ping-pong handover event management module is configured to: receive a re-association request from an electronic device, wherein electronic device is previously connected with a first AP among the plurality of APs, and the electronic device detects that a number of ping-pong handover events between the first AP and the second AP exceeds a defined threshold value. The re-association request comprises an indication of a required service type for the electronic device and a flag indicating a requirement for assistance for the electronic device. The ping-pong handover event management module is further configured to: generate a recommendation based on the received association request; and transmit Station (STA) assistance information to the electronic device to manage the required service type for the electronic device, wherein the STA assistance information comprises the generated recommendation.

According to an example embodiment of the present disclosure, an Access Point (AP) for handling a ping-pong handover event between a plurality of APs in a wireless communication network is disclosed. The AP includes a system, the system includes a ping-pong handover event management module comprising circuitry coupled with a memory, at least one processor, comprising processing circuitry, and a communicator comprising communication circuitry. The ping-pong handover event management module may be included in at least one processor or implemented by at least one processor. The ping-pong handover event management module is configured to: receive a Station (STA) assistance request from an electronic device, wherein the electronic device is prior connected with the first AP, and a service type event is triggered at the electronic device due to a number of ping-pong handover events between the first AP and the second AP exceeding a defined threshold value. The STA assistance request comprises an indication of a service type event required for the electronic device, and a ping-pong flag indicating a requirement for assistance for the electronic device. The ping-pong handover event management module is further configured to: generate a recommendation based on the received STA assistance request; and transmit a STA assistance response to the electronic device to manage the service type event required for the electronic device, wherein the STA assistance response comprises the generated recommendation.

To further illustrate various advantages and features of the present disclosure, a more detailed description will be rendered with reference to various example embodiments thereof, which are illustrated in the appended drawings. It is appreciated that these drawings depict example embodiments and are therefore not to be considered limiting of its scope.

### BRIEF DESCRIPTION OF THE DRAWINGS

These and other features, aspects, and advantages of certain embodiments of the present disclosure will be more apparent from the following detailed description, taken in conjunction with the accompanying drawings in which like characters represent like parts throughout the drawings and in which:

FIG. 1 is a diagram of digital device ecosystem, according to related art;

FIGS. 2A, 2B, 3A, 3B, and 4 are diagrams illustrating various problem scenarios associated with a ping-pong roaming (ping-pong handover event) in the current wireless communication standard, according to related art;

FIG. 5 is a block diagram illustrating an example configuration of an electronic device for handling the ping-pong handover event between a plurality of Access Points (APs) in a wireless communication network, according to various embodiments;

FIG. 6 is a block diagram illustrating an example configuration of an Access Point (AP) for handling the ping-pong handover event, according to various embodiments;

FIG. 7 is a signal flow diagram illustrating an example method for handling the ping-pong handover event between the plurality of APs in the wireless communication network, according to various embodiments;

FIG. 8 is a diagram illustrating an example STA assistance element frame structure associated with association and re-association request messages, according to various embodiments;

FIG. 9 is a diagram illustrating an example STA assistance information frame structure, according to various embodiments;

FIG. 10 is a flowchart illustrating example operations performed by the electronic device to handle the ping-pong handover event between the plurality of APs in the wireless communication network, according to various embodiments;

FIG. 11 is a flowchart illustrating example operations performed by the AP to handle the ping-pong handover event, according to various embodiments;

FIG. 12 is a signal flow diagram illustrating an example method for handling the ping-pong handover event between the plurality of APs in the wireless communication network, according to various embodiments;

FIG. 13 is a diagram illustrating an example STA assistance request message frame structure, according to various embodiments;

FIG. 14 is a diagram illustrating an example STA assistance response message frame structure, according to various embodiments;

FIG. 15 is a flowchart illustrating example operations performed by the electronic device to handle the ping-pong handover event between the plurality of APs in the wireless communication network, according to various embodiments; and

FIG. 16 is a flowchart illustrating example operations performed by the AP to handle the ping-pong handover event, according to various embodiments.

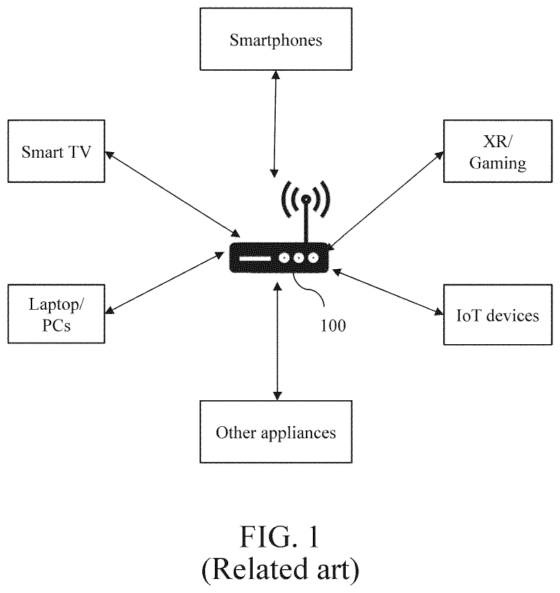

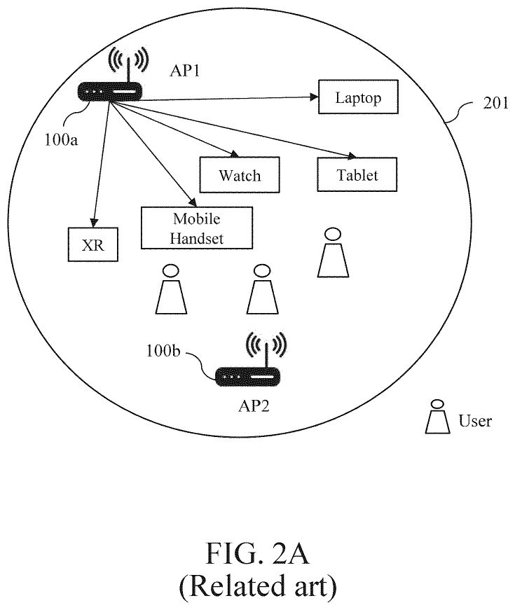

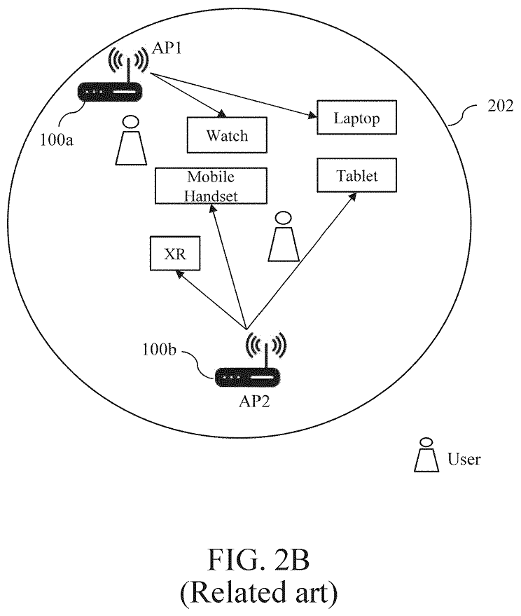

Further, those skilled in the art will appreciate that elements in the drawings are illustrated for simplicity and may not have necessarily been drawn to scale. For example, the flowcharts may illustrate the method in terms of operations involved to help to improve understanding of aspects of the present disclosure. Furthermore, in terms of the construction of the device, one or more components of the device may have been represented in the drawings by conventional symbols, and the drawings may illustrated details pertinent to understanding the disclosure so as not to obscure the drawings with details that will be readily apparent to those skilled in the art having the benefit of the description herein.

### DETAILED DESCRIPTION

Reference will now be made to various example embodiments illustrated in the drawings and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would occur to those skilled in the art to which the disclosure relates.

It will be understood by those skilled in the art that the foregoing general description and the following detailed description are explanatory and are not intended to be restrictive thereof.

Use of the phrases and/or terms including, but not limited to, “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or other variants thereof do not necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or in the context of more than one embodiment, or in the context of all embodiments, the features and/or elements may instead be provided separately or in any appropriate combination or not at all. Conversely, any features and/or elements described in the context of separate embodiments may alternatively be realized as existing together in the context of a single embodiment.

The terms “comprise”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

The term “couple” and the derivatives thereof refer to any direct or indirect communication between two or more elements, whether or not those elements are in physical contact with each other. The terms “transmit”, “receive”, and “communicate” as well as the derivatives thereof encompass both direct and indirect communication. The term “or” is an inclusive term meaning “and/or”. The phrase “associated with,” as well as derivatives thereof, refer to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” refers to any device, system, or part thereof that controls at least one operation. The functionality associated with any particular controller may be centralized or distributed, whether locally or remotely. The phrase “at least one of,” when used with a list of items, may refer, for example, to different combinations of one or more of the listed items may be used, and only one item in the list may be needed. For example, “at least one of A, B, and C” includes any of the following combinations: A, B, C, A and B, A and C, B and C, and A and B and C, and any variations thereof. As an additional example, the expression “at least one of a, b, or c” may indicate only a, only b, only c, both a and b, both a and c, both b and c, all of a, b, and c, or variations thereof. Similarly, the term “set” may refer to one or more. Accordingly, the set of items may be a single item or a collection of two or more items. The phrase “one or more of,” when used with a list of items, may refer to different combinations of one or more of the listed items may be used, and only one item in the list may be needed. For example, “one or more of: A, B, of C” includes any of the following combinations: A, B, C, A and B, A and C, B and C, and A and B and C.

The various example embodiments herein and the various features and advantageous details thereof are explained more fully with reference to the non-limiting embodiments that are illustrated in the accompanying drawings and detailed in the following description. Descriptions of well-known components and processing techniques may be omitted so as to not unnecessarily obscure the disclosure herein. The various example embodiments described herein are not necessarily mutually exclusive, as various embodiments can be combined with one or more other embodiments to form new embodiments. The term “or” as used herein, refers to a non-exclusive or unless otherwise indicated. The examples used herein are intended merely to facilitate an understanding of ways in which the various embodiments herein can be practiced and to further enable those skilled in the art to practice the various embodiments herein. Accordingly, the examples should not be construed as limiting the scope of the disclosure.

Various example embodiments may be described and illustrated in terms of blocks that carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware and software. The circuits may, for example, be embodied in one or more semiconductor chips, or on substrate supports such as printed circuit boards and the like. The circuits of a block may be implemented by dedicated hardware, or by a processor (e.g., one or more programmed microprocessors and associated circuitry), or by a combination of dedicated hardware to perform some functions of the block and a processor to perform other functions of the block. Each block of the various embodiments may be physically separated into two or more interacting and discrete blocks without departing from the scope of the disclosure. Likewise, the blocks of the various embodiments may be physically combined into more complex blocks without departing from the scope of the disclosure.

The accompanying drawings are used to help easily understand various technical features, and it should be understood that the various example embodiments presented herein are not limited by the accompanying drawings. As such, the present disclosure should be understood to extend to any alterations, equivalents, and substitutes in addition to those which are particularly set out in the accompanying drawings. Although the terms first, second, etc., may be used herein to describe various elements, these elements should not be limited by these terms. These terms are generally only used to distinguish one element from another.

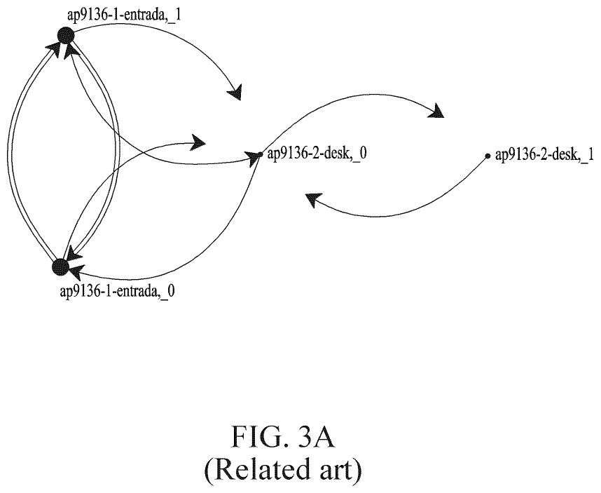

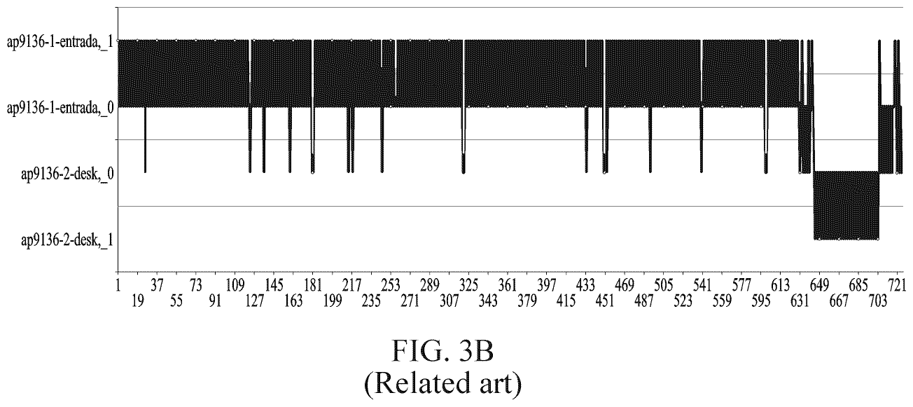

In the context of a ping-pong handover event, the IEEE 802.11 24/0519r2 document analyzes the frequency of ping-pong handover events in a typical environment with four Access Points (APs), illustrated in FIGS. 3A and 3B. FIG. 3A depicts an office layout with four APs, showing how a Station (STA) moves between these APs due to temporary obstructions. FIG. 3B presents a graph with APs on the Y-axis and time on the X-axis, demonstrating that the STA frequently transitions between APs.

Current statistics indicate that multiple ping-pong events continue to impact STAs (e.g., electronic devices) due to temporary obstructions, highlighting the need for improved specifications in Ultra High Reliability (UHR) standards.

In certain existing methods, for instance, the AP can observe one or more ping pong roams and warn the STA, a mere historical record, or more advanced techniques (e.g., AI and/or ML) are used to derive a conclusion on what to convey to the user device (STA).

In certain existing methods, for instance, the AP might report 20 successful roaming events over the last 1800 seconds and recommend dampening roaming triggers for the next 20 minutes or adjusting based on significant Received Signal Strength Indicator (RSSI) changes.

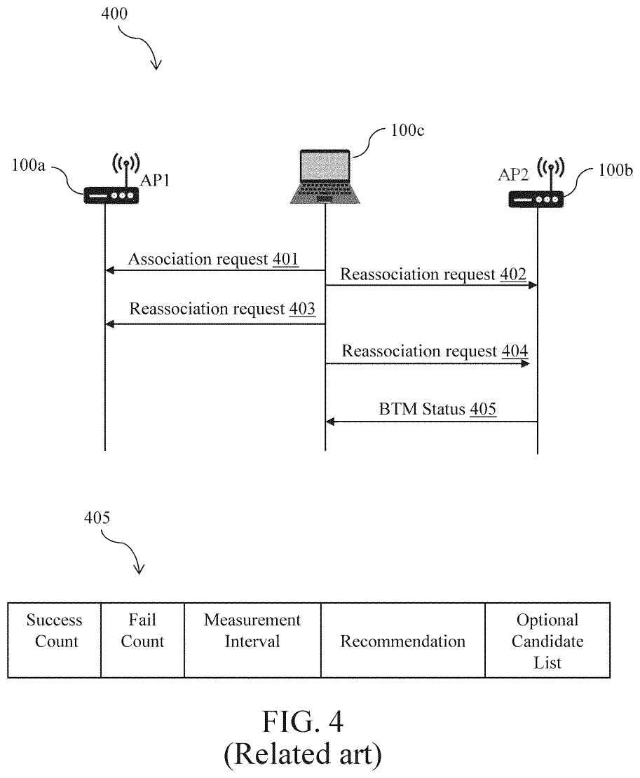

Certain existing methods have explored the use of BSS Transition Management (BTM) statistics messages, as illustrated in FIG. 4. In a typical scenario 400, an electronic device 100c connects to the first AP (AP1) 100a via an association request 401. Temporary factors, such as human obstructions, can lead to a decrease in signal strength from the AP1 100a. When signal strength falls below acceptable levels, the electronic device 100c initiates a scan and connects to a second AP (AP2) 100b through a reassociation request 402. Once the obstruction is cleared and AP1's signal improves, the electronic device 100c reconnects to the AP1 100a through a reassociation request 403. When the signal strength from AP1 100a falls below acceptable levels, the electronic device 100c reconnects to AP2 100b through a reassociation request 404 again. This process (e.g., reassociation requests 403 and 404) may be repeated due to recurring obstructions. The APs can observe ping-pong roaming patterns and communicate with STAs using the BTM statistics message 405. These BTM statistics message 405 can include one or more parameters, for instance, status count, fail count, measurement interval, recommendations, and a list of alternative APs (optional candidate list) based on observed data. The BTM statistics message 405 is used in Wi-Fi networks to facilitate seamless roaming between different APs by allowing clients (electronic device 100c) to discover and connect to better APs. However, several problems are encountered in the above-mentioned existing method(s), which are mentioned below.

One issue is the “ping-pong” effect, where client devices (STAs) frequently switch between multiple APs due to temporary signal interruptions. Each STA has its own thresholds and roaming algorithms, which can vary based on the hardware capabilities and how they handle signal conditions. Moreover, the current environment includes a wide variety of devices, each with different requirements for latency, throughput, reliability, and power savings. Existing solutions primarily focus on APs sending generic recommendations to the STAs, which may use proprietary or machine learning algorithms. However, these recommendations often fail to consider the specific needs of individual STAs, leading to suboptimal performance. The following problems can occur if STA requirements are not taken into account.
a. Impact on STA performance: Recommendations from existing methods may overlook important factors such as power saving, throughput, latency, and reliability. As a result, they provide generic advice that does not effectively address the ping-pong issue, potentially degrading STA performance.
b. STA thresholds:
   i. STA ping pong counter: Different STAs have varying levels of resilience to ping-pong behavior. Relying on a single threshold set by the AP may not be appropriate, as some STAs may require different handling based on their specific needs.
   i. Roaming threshold impact: Each STA has its own roaming thresholds. If the AP uses a one-size-fits-all approach for generating recommendations, it may not align with the individual thresholds of the STAs, leading to ineffective decision-making.
c. Need for tailored recommendations: Current recommendations are often too generic, failing to adapt to the unique situations and requirements of the STAs. A more customized approach is necessary to meet the specific needs and thresholds of each electronic device.

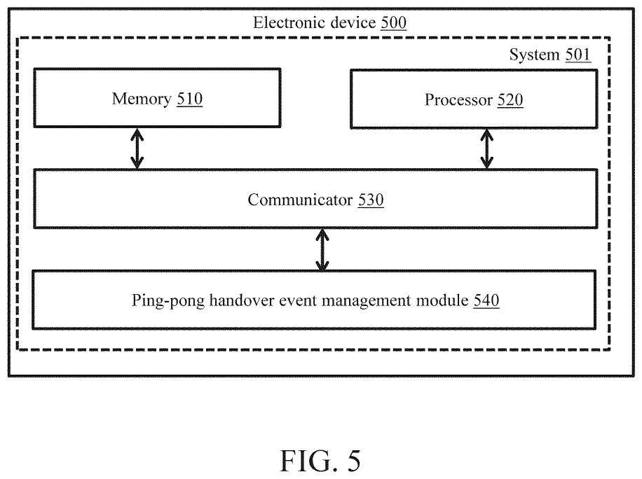

To address the above-mentioned challenges/problems, a disclosed method provides a unique strategy for handling the ping-pong handover event between the plurality of APs in the wireless communication network, as described in greater detail below with reference to FIG. 5 to FIG. 16. The disclosed method and/or system provides a new framework to communicate the STA performance and preference indicators to the AP and receive a recommendation that is more tailored for the STA based on its indicators to handle the ping pong issues. The disclosed method and/or system may belong to the ongoing efforts for Wi-Fi8 standardization activity in IEEE 802.11 standards (TGbn) and targets the enhancement of seamless roaming and ping pong issues.

Reference will now be made to various example embodiments illustrated in the drawings, for example, FIGS. 5 to 16, where similar reference characters denote corresponding features consistently throughout the figures.

FIG. 5 is a block diagram illustrating an example configuration of an electronic device 500 for handling the ping-pong handover event between a plurality of Access Points (APs) in a wireless communication network, according to various embodiments. Examples of the electronic device 500 include, but are not limited to, a station (STA), a smartphone, a tablet computer, a Personal Digital Assistant (PDA), an Internet of Things (IOT) device, a wearable device, etc.

In various example embodiments, the electronic device 500 comprises a system 501. The system 501 may include a memory 510, a processor (e.g., including processing circuitry) 520, a communicator (e.g., including communication circuitry) 530, and a ping-pong handover event management module (e.g., including various circuitry and/or executable program instructions) 540. In various examples, the system 501 may be implemented on one or multiple electronic devices (not shown in FIG. 5).

In various example embodiments, the memory 510 may be coupled, directly or indirectly, to the processor 520, the communicator 530, and/or the ping-pong handover event management module 540. The memory 510 may store instructions that, when executed by at least one processor, comprising processing circuitry, individually or collectively, cause the electronic device 500, which can be an STA, to perform the methods and/or the operations described herein. The at least one processor may include the combination of one or more processors such as the processor 520, the processing circuitry in the communicator 530, the processing circuitry in the ping-pong handover event management module 540, a CPU, GPU, MPU, an application processor (AP), and a communication processor (CP). The processing circuitry in the communicator 530 may be included in the processor 602. The processing circuitry in the ping-pong handover event management module 540 may be included in the processor 520. Thus, the processor 520 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The memory 510 may include non-volatile storage elements. Examples of such non-volatile storage elements may include magnetic hard discs, optical discs, floppy discs, flash memories, or forms of Electrically Programmable Memories (EPROM) or Electrically Erasable and Programmable (EEPROM) memories. In addition, the memory 510 May in some examples, be considered a non-transitory storage medium. The “non-transitory” storage medium is not embodied in a carrier wave or a propagated signal. However, the term “non-transitory” should not be interpreted as the memory 510 is non-movable. In various examples, the memory 510 can be configured to store larger amounts of information than the memory. In certain examples, a non-transitory storage medium may store data that can, over time, change (e.g., in Random Access Memory (RAM) or cache). The memory 510 can be an internal storage unit, or it can be an external storage unit of the electronic device 500, a cloud storage, or any other type of external storage.

In various example embodiments, the processor 520 communicates with the memory 510, the communicator 530, and the ping-pong handover event management module 540. The communicator 530 and/or the ping-pong handover event management module 540 may be controlled by the processor 520. The processor 520 is configured to execute instructions stored in the memory 510 and to perform various processes for handling the ping-pong handover event between the plurality of APs in the wireless communication network, as discussed throughout the disclosure. The processor 520 may include one or a plurality of processors, maybe a general-purpose processor, such as a Central Processing Unit (CPU), an Application Processor (AP), or the like, a graphics-only processing unit such as a Graphics Processing Unit (GPU), a Visual Processing Unit (VPU), and/or an Artificial Intelligence (AI) dedicated processor such as a Neural Processing Unit (NPU).

In various example embodiments, the communicator 530 may include various communication circuitry and is configured for communicating internally between internal hardware components and with external devices (e.g., server, APs, etc.) via one or more networks (e.g., radio technology). The communicator 530 includes an electronic circuit specific to a standard that enables wired or wireless communication. The communicator 530 may be included in the processor 510 or implemented by the processor 510.

In various example embodiments, the ping-pong handover event management module 540 is implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like. The ping-pong handover event management module 540 may be included in the processor 510 or implemented by the processor 510.

In various example embodiments, the ping-pong handover event management module 540 is configured to perform one or more operations to handle the ping-pong handover event between the plurality of APs in the wireless communication network, which are given below.

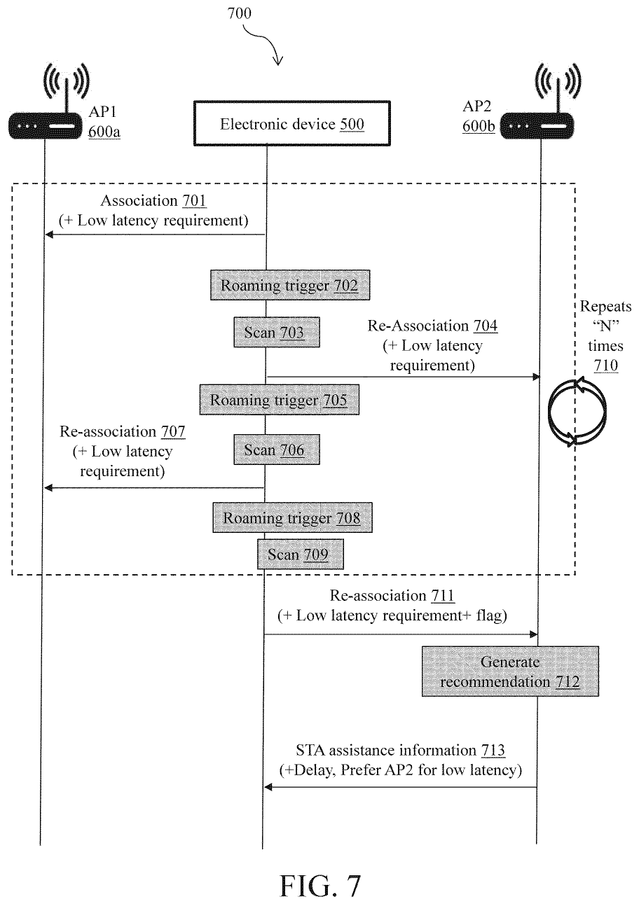

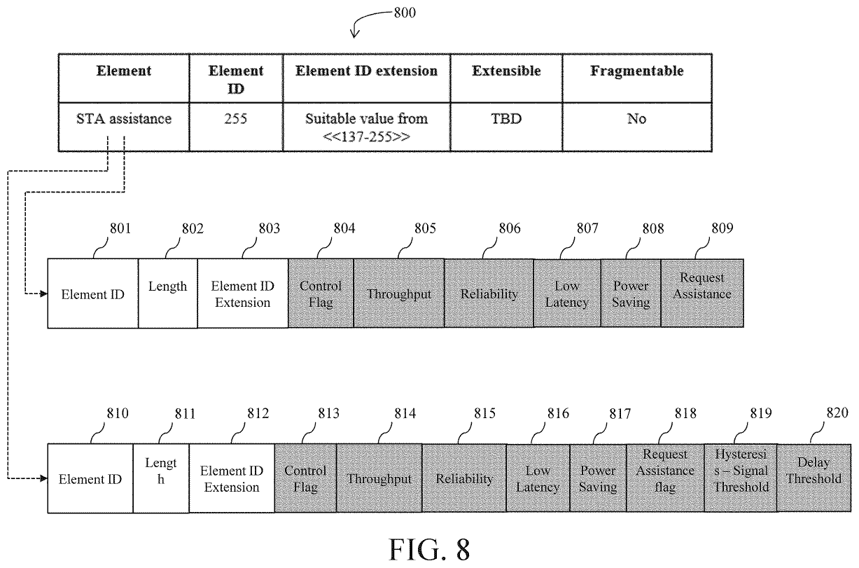

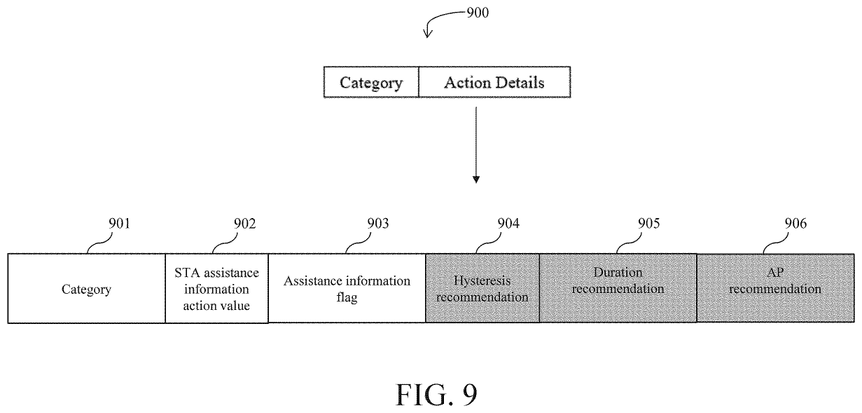

For instance, the ping-pong handover event management module 540 is configured to detect an occurrence of a number of ping-pong handover events between a first AP among the plurality of APs and a second AP among the plurality of APs, as described in greater detail below with reference to FIG. 7. The ping-pong handover event management module 540 is further configured to determine whether the number of ping-pong handover events between the first AP and the second AP exceeds a defined threshold value (e.g., 10). The ping-pong handover event management module 540 is further configured to transmit a re-association request to the second AP, wherein the electronic device 500 is previously connected with the first AP in response to determining that the number of the ping-pong handover events between the first AP and the second AP exceeds the defined threshold value, as described in greater detail below with reference to FIG. 8. The re-association request comprises an indication of a required service type for the electronic device 500 and a flag indicating a requirement for assistance for the electronic device 500. The ping-pong handover event management module 540 is further configured to receive Station (STA) assistance information from the second AP to manage the required service type for the electronic device 500 in response to transmitting the re-association request, as described in greater detail below with reference to FIG. 9.

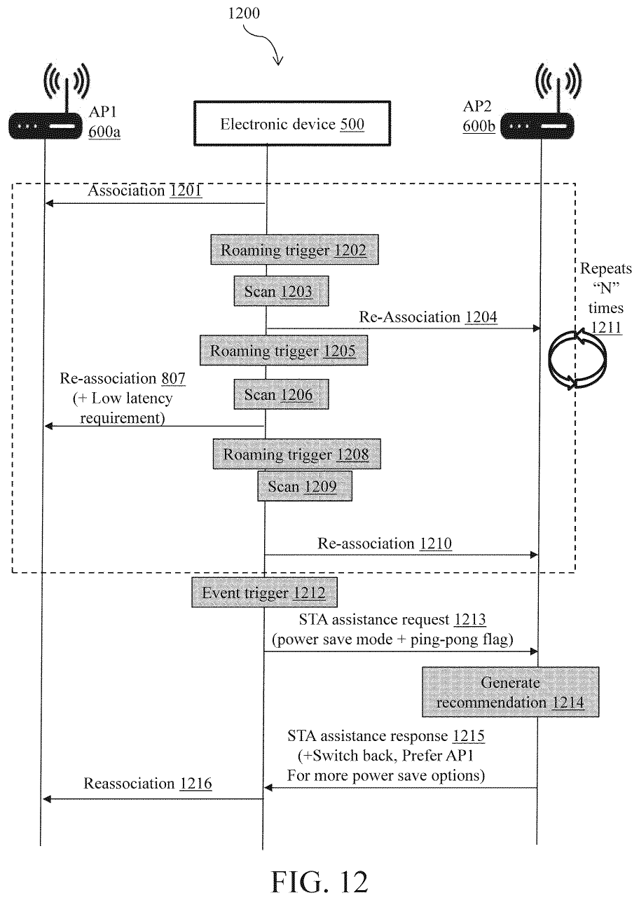

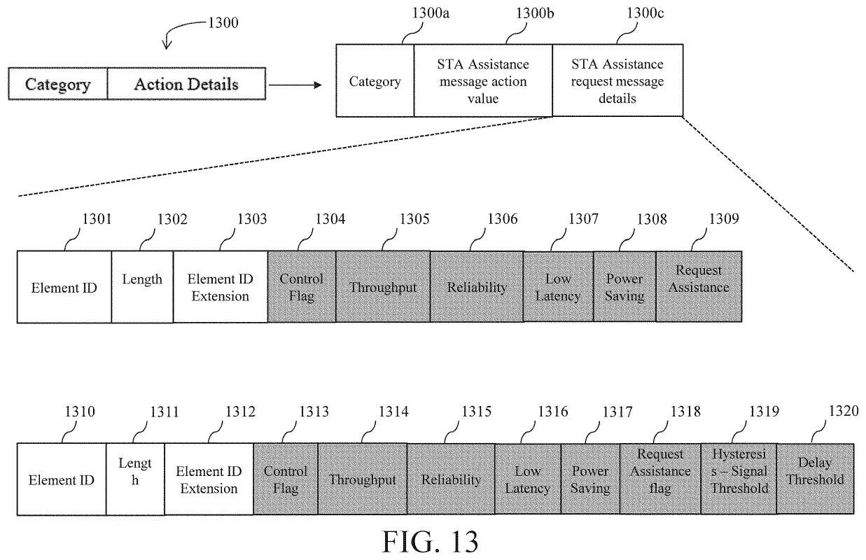

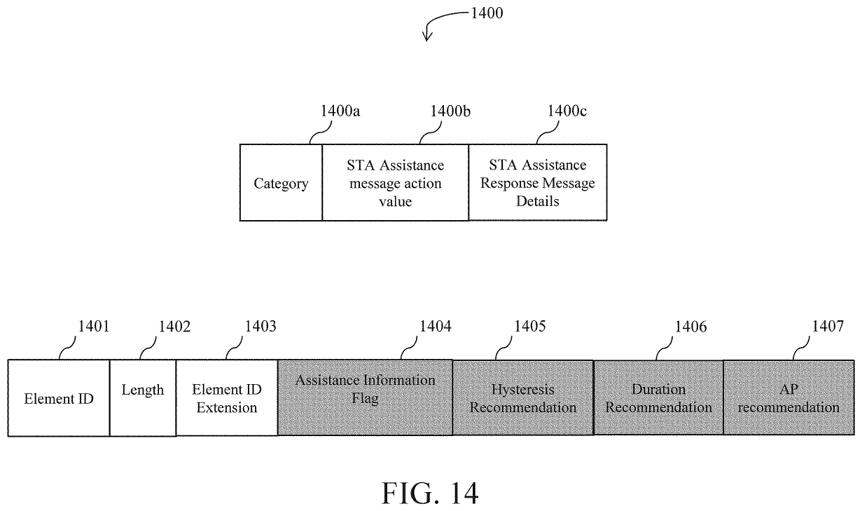

For another instance, the ping-pong handover event management module 540 is configured to detect an occurrence of a number of ping-pong handover events between the first AP and the second AP, as described in greater detail below with reference to FIG. 12. The ping-pong handover event management module 540 is further configured to determine whether the number of ping-pong handover events between the first AP and the second AP exceeds the defined threshold value (e.g., 10). The ping-pong handover event management module 540 is further configured to trigger a service type event in the electronic device 500 in response to determining that the number of the ping-pong handover events between the first AP and the second AP exceeds the defined threshold value. The service type event may include, for example, but is not limited to, a power saving event, a throughput event, a latency event, or a reliability event. The ping-pong handover event management module 540 is further configured to transmit a Station (STA) assistance request to the second AP, wherein the electronic device 500 is prior connected with the first AP in response to triggering the service type event, as described in greater detail below with reference to FIG. 13. The STA assistance request comprises an indication of a service type event required for the electronic device 500 and a ping-pong flag indicating a requirement for assistance for the electronic device 500. The ping-pong handover event management module 540 is further configured to receive a STA assistance response from the second AP to manage the service type event required for the electronic device in response to transmitting the STA assistance request. The STA assistance response indicates a preferable AP among the plurality of APs for the service type event, as described in greater detail below with reference to FIG. 14.

In various example embodiments, a function associated with the various components of the electronic device 500 may be performed through the non-volatile memory, the volatile memory, and the processor 520. One or a plurality of processors controls the processing of the input data in accordance with a predefined operating rule or AI model stored in the non-volatile memory and the volatile memory. The predefined operating rule or AI model is provided through training or learning. Here, being provided through learning may refer, for example, to, by applying a learning algorithm to a plurality of learning data, a predefined operating rule or AI model of the desired characteristic being made. The learning may be performed in a device itself in which AI according to an example embodiment is performed, and/or may be implemented through a separate server/system. The learning algorithm is a method for training a predetermined target device (for example, a robot) using a plurality of learning data to cause, allow, or control the target device to decide or predict. Examples of learning algorithms include, but are not limited to, supervised learning, unsupervised learning, semi-supervised learning, or reinforcement learning. The AI model may include a plurality of neural network layers. Each layer has a plurality of weight values and performs a layer operation through a calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

Although FIG. 5 shows various hardware components of the electronic device 500, but it is to be understood that other examples are not limited thereto. In various examples, the electronic device 500 may include less or more number of components. Further, the labels or names of the components are used only for illustrative purposes and do not limit the scope of the disclosure. One or more components can be combined to perform the same or substantially similar functions for handling the ping-pong handover event between the plurality of APs in the wireless communication network.

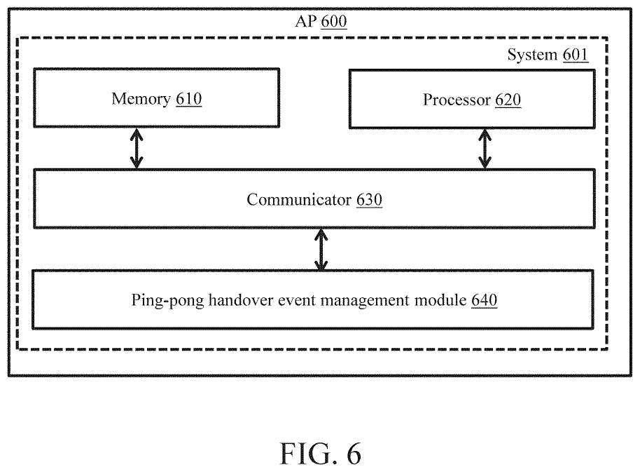

FIG. 6 is a block diagram illustrating an example configuration of the AP 600 (e.g., first AP, second AP, etc.) for handling the ping-pong handover event, according to various embodiments.

In various example embodiments, the AP 600 comprises a system 601. The system 601 may include a memory 610, a processor (e.g., including processing circuitry) 620, a communicator (e.g., including communication circuitry) 630, and a ping-pong handover event management module (e.g., including various circuitry and/or executable program instructions) 640. In various example embodiments, the system 601 may be implemented on one or multiple electronic devices (not shown in FIG. 5). Basic functionalities associated with various modules, such as the memory 610, the processor 620, and the communicator 630 is the same as or similar to that mentioned in FIG. 5 and may not be repeated here for the sake of brevity.

In various example embodiments, the ping-pong handover event management module 640 is configured to perform one or more operations to handle the ping-pong handover event between the plurality of APs in the wireless communication network, which are given below.

For instance, the ping-pong handover event management module 640 is configured to receive the re-association request from the electronic device 500, as described in greater detail below with reference to FIG. 7. Herein, the electronic device 500 is previously connected with the first AP, and the electronic device 500 is detected that the number of ping-pong handover events between the first AP and the second AP exceeds the defined threshold value, as described in greater detail below with reference to FIG. 8. The re-association request comprises the indication of the required service type for the electronic device 500 and the flag indicating the requirement for assistance for the electronic device 500. The ping-pong handover event management module 640 is further configured to generate a recommendation based on the received association request. The ping-pong handover event management module 640 is further configured to transmit the STA assistance information to the electronic device 500 to manage the required service type for the electronic device 500, where the STA assistance information comprises the generated recommendation, as described in greater detail below with reference to FIG. 9.

For another instance, the ping-pong handover event management module 540 is configured to receive the STA assistance request from the electronic device 500, as described in greater detail below with reference to FIG. 12. The electronic device 500 is previously connected with the first AP, and the service type event is triggered at the electronic device 500 due to the number of ping-pong handover events between the first AP and the second AP exceeding the defined threshold value. The STA assistance request comprises an indication of a service type event required for the electronic device 500, and a ping-pong flag indicating a requirement for assistance for the electronic device 500, as described in greater detail below with reference to FIG. 13. The ping-pong handover event management module 640 is further configured to generate a recommendation based on the received STA assistance request. The ping-pong handover event management module 640 is further configured to transmit the STA assistance response to the electronic device 500 to manage the service type event required for the electronic device 500, where the STA assistance response comprises the generated recommendation, as described in greater detail below with reference to FIG. 14.

Although FIG. 6 shows various hardware components of the AP 600, but it is to be understood that other examples are not limited thereto. In various examples, the AP 600 May include less or more components. Further, the labels or names of the components are used only for illustrative purposes and do not limit the scope of the disclosure. One or more components can be combined to perform the same or substantially similar functions for handling the ping-pong handover event between the plurality of APs in the wireless communication network.

FIG. 7 is a signal flow diagram illustrating an example method 700 for handling the ping-pong handover event between the plurality of APs (e.g., AP1 600a and AP2 600b) in the wireless communication network, according to various embodiments. The method 700 may execute multiple operations to handle the ping-pong handover event, which are given below.

In operation 701, the electronic device 500 (or referred to as “STA”) sends an association request to AP1 600a with the indication of a low latency requirement. Due to temporary blockages, in operations 702-703, the electronic device 500 experiences a loss of signal and this triggers a roaming condition in the electronic device 500 and the electronic device 500 scans and finds that the AP2 600b is available, whose signal threshold is lower than the AP1 600a originally, but meets the roaming threshold conditions better at this time. In operation 704, the AP2 600b receives the re-association request message that includes the newly defined performance requirement message, like the low latency requirement.

In operations 705-706, when the temporary blockage is cleared, the electronic device 500 finds that the AP1 600a is better and that triggers the roaming condition and finds the AP1 600a. In operation 707, the electronic device 500 sends another re-association request message to the AP1 600a. In operations 708-709, when temporary issues can occur that can cause the roaming trigger and scan. In operation 710, the processes (e.g., 701 to 709) can repeat N number of times (which can be maintained by the electronic device 500 and can be implementation specific). Once the N times ping-pong is reached, the disclosed method is triggered.

In operation 711, another re-association process can be initiated, by the electronic device 500, and this time, along with requirements, it can also send a flag to indicate that it needs assistance to the AP2 600b. In operation 712, the AP2 600b can generate the recommendation, taking inputs from the electronic device 500 about its performance requirements (e.g., low latency requirement) and also the timing at which it needs the recommendation. Finally, in operation 713, the AP2 600b can send out a recommendation suitable to handle the low latency requirement to the electronic device 500. For example, in this scenario, it's possible that the AP2 600b, though, is slightly lower in signal conditions but provides better support for low-latency data than the AP1 600a due to congestion at the AP1 600a.

FIG. 8 is a diagram illustrating an example STA assistance element frame structure 800 associated with the association and re-association request messages (related to operations 701, 704, 707, 711, etc.), according to various embodiments.

In various example embodiments, the re-association request and the association request comprise STA assistance information to provide the indication of the required service type for the electronic device 500. Similarly, this can be included in other management frames too, like probe request in one alternative of the solution. The association request frame body is disclosed in Table 1 below, and the re-association request frame body is disclosed in Table 2 below.

TABLE 1

| Order | Information | Notes |
|---|---|---|
| 1 | Capability | See 9.4.1.4 (capability information |
| | information | field) for capability information |
| | | field format. |
| #Previousorder + | STA | Detailed frame format is illustrated |
| 1 | assistance | in FIG. 8 (referred to as “800”) |
| Last | Vendor | One or more vendor-specific elements |
| | specific | are optionally present. These |
| | | elements follow all other elements. |

TABLE 2

| Order | Information | Notes |
|---|---|---|
| 1 | Capability | See 9.4.1.4 (capability information |
| | information | field) for capability information |
| | | field format. |
| #Previousorder + | STA | Detailed frame format is illustrated |
| 1 | assistance | in FIG. 8 (referred to as “800”) |
| Last | Vendor | One or more vendor-specific elements |
| | specific | are optionally present. These |
| | | elements follow all other elements. |

In various example embodiments, STA assistance information comprises a plurality of parameters, for example, as described in Table 3 below.

In various example embodiments, the plurality of parameters may include, but is not limited to, an identity of element 801, a length of element 802, an element ID extension 803, a control flag 804, and at least one required service type, the at least one service type comprises a throughput preference 805, a reliability preference 806, a low latency preference 807, a power saving preference 808, and a request assistance 809.

In various example embodiments, the plurality of parameters may include, but is not limited to, the identity of element 810, the length of element 811, the element ID extension 812, the control flag 813, and at least one required service type, the at least one service type comprises the throughput preference 814, the reliability preference 815, the low latency preference 816, the power saving preference 817, a request assistance flag 818, a hysteresis signal threshold 819, and a delay threshold 820.

TABLE 3

| Subfield | Definition | Encoding |
|---|---|---|
| Control flag | This subfield defines | 0001: Includes Throughput preference |
| (804 and 813) | whether the STA | (if 0- no throughput preference) |
| | assistance information | 0010: Includes Reliability preference |
| | may include throughput, | (if 0- no reliability preference) |
| | reliability, low latency, | 0100: Includes Low Latency preference |
| | power saving | (if 0- no low latency preference) |
| | preference, or not. | 1000: Includes power saving preference |
| | | (if 0- no power saving preference) |
| Throughput | This subfield defines the | The encoding can be included in one variant: |
| (805 and 814) | throughput requirements | 001: Low Throughput, 010: Medium |
| | of the STA. | Throughput, 100: High Throughput |
| | | In another variant of the solution: |
| | | A few bits to indicate the data rate in Mbps |
| Reliability | This subfield defines the | The encoding can be included in one |
| (806 and 815) | reliability preference | variant of the solution: |
| | of the STA. | 001: Low Reliability, 010: Medium |
| | | Reliability, 100: High Reliability |
| | | Other variants of encoding can be to |
| | | indicate the error rate tolerance value. |
| Low latency | This subfield defines the | The encoding can be included in one |
| (807 and 816) | low-latency preference | variant of the solution: |
| | of the STA. | The value indicates latency tolerance or |
| | | latency requirement in numbers. |
| Power saving | This subfield defines the | The encoding can be included in one |
| (808 and 817) | power-saving preference | variant of the solution: |
| | of the STA. | 001: Low Power saving, 010: Medium |
| | | power saving, 100: High power saving |
| | | In another variant of the solution, it can |
| | | indicate the power save category value if |
| | | defined in the specification. |
| Request | This subfield represents | This can be a one-bit flag. 0-Indicates no |
| assistance/request | the requirement of STA | assistance required, 1-indicates assistance |
| assistance flag | that it needs assistance. | required (809). |
| (809 and 818) | | The request assistance flag (818) can be a |
| | | set of bits to indicate whether assistance is |
| | | needed and an indication to tell the device |
| | | status. For example, when the device |
| | | battery level is low, further hysteresis of |
| | | signal threshold can be reduced in |
| | | recommendation by AP to help STA save |
| | | more batteries. |
| | | Bit 1: 0- Indicates no request for |
| | | Assistance, 1- Indicates a request for |
| | | assistance. |
| | | Bit 2: 1- Indicates Hysteresis for Signal |
| | | threshold is present in STA preference, 0- |
| | | indicates absence. |
| | | Bit 3: 1- Indicates delay for roaming |
| | | thresholds to be applied is present, 0- |
| | | indicates absence. |
| Hysteresis - signal | This subfield is present | The encoding can be defined as follows: |
| threshold | in the variant of the | A set of bits can indicate a minimum and |
| (819) | solution that follows | maximum range of hysteresis thresholds |
| | implementation, which | tolerable at STA. |
| | represents the minimum | 0 − X bits: Indicate minimum value |
| | and maximum hysteresis | X + 1 − Y bits: Indicate maximum value |
| | thresholds suitable for STA. | |
| | A hysteresis threshold is | |
| | a certain signal threshold | |
| | value that can be | |
| | indicated by the AP to | |
| | the STA(device) to add | |
| | an offset to the device's | |
| | own implemented threshold | |
| | values for roaming. | |
| Delay threshold | This subfield is present | The encoding can be defined as follows: |
| (820) | in the variant of the | A set of bits can indicate a minimum and |
| | solution that follows | maximum range of delay thresholds |
| | implementation, which | tolerable at STA. |
| | indicates the minimum | 0 − X bits: Indicate minimum value |
| | and maximum delays | X + 1 − Y bits: Indicate maximum value |
| | suitable for STA. | |
| | Delay threshold can be | |
| | defined as a time | |
| | interval for which the | |
| | device can wait after a | |
| | roaming condition has | |
| | occurred, as per the | |
| | device's own | |
| | implementation, before | |
| | it can trigger roaming. | |
| | This can delay the | |
| | roaming and solve ping- | |
| | pong issues. | |

FIG. 9 is a diagram illustrating an example STA assistance information frame structure 900 (related to operation 713), according to various embodiments. The STA assistance information frame structure 900 comprises a plurality of parameters.

In various example embodiments, the STA assistance information message may be defined as an action frame. Action Frames are an extension to existing management frames, and the format for the STA assistance Information can be described below in Table 4. The STA assistance information category value is added to the table of category values, and its associated action frame details are discussed herein.

TABLE 4

| | | | | Group |
|---|---|---|---|---|
| | | | | addressed |
| Code | Meaning | See Subclause | Robust | privacy |
| 0 | Spectrum | 9.6.2 (Spectrum | Yes | No |
| | management | Management | | |
| | | Action frame | | |
| | | details(#3729)) | | |
| #Chosing | STA | STA Assistance | Yes | No |
| value | assistance | Information | | |
| between | information | Action frame | | |
| <35-125> | | Details | | |
| 128-255 | Reserved | NA | NA | NA |

In various example embodiments, the plurality of parameters may include, but are not limited to, a category value 901, a STA assistance information action value 902, an assistance information flag 903, a hysteresis recommendation 904, a duration recommendation 905, and an AP recommendation 906.

In various example embodiments, the STA assistance information action value 902 indicates a presence or reservation of the STA assistance information, for example, as described in Table 5 below.

TABLE 5

| STA assistance | |
|---|---|
| information action value | Meaning |
| 0 | STA assistance information is present. |
| 1 | Reserved |

In various example embodiments, the assistance information flag 903 is represented by a set of bits that indicate whether one or more packets comprise a hysteresis signal, a duration, and an AP recommendation, a roaming recommendation, or one or more reserved bits, for example, as described in Table 6 below.

TABLE 6

| Code | Name | Meaning |
|---|---|---|
| Bit 0 | Hysteresis | 0- Hysteresis Recommendation present |
| | signal | 1 - Hysteresis Recommendation absent |
| Bit 1 | Duration | 0-Duration Recommendation present |
| | | 1 - Duration Recommendation absent |
| Bit 2 | AP | 0- AP recommendation present |
| | recommendation | 1- AP recommendation absent |
| Bit 3 | No roaming | 1 - Do not roam and stay on the current AP |

In various example embodiments, the hysteresis recommendation 904 indicates a type of hysteresis requirements for the electronic device, comprising one of a no hysteresis, a positive hysteresis, and a negative hysteresis, for example, as described in Table 7 below.

TABLE 7

| Code | Name | Meaning |
|---|---|---|
| X Bits | Hysteresis | It can include a value of positive or negative |
| | recom- | hysteresis. To indicate an early or late roaming |
| | mendation | transition. The details of this encoding can be |
| | | further added in a future IP when the solution |
| | | matures. It can broadly include values like: No |
| | | hysteresis, positive hysteresis, or negative |
| | | hysteresis. |

In various example embodiments, the duration recommendation 905 indicates whether action is immediate or occurs after a defined time units, as recommended by at least one second AP 600b, for example, as described in Table 8 below.

TABLE 8

| Code | Name | Meaning |
|---|---|---|
| X Bits | Duration | It can include encoding such that, duration |
| | recommendation | can be immediate action or after a few Time |
| | | Units as per the recommendation by the AP. |

In various example embodiments, the AP recommendation 906 indicates a list of suitable APs based on one or more preferences indicated by the electronic device 500, for example, as described in Table 9 below.

TABLE 9

| Code | Name | Meaning |
|---|---|---|
| X Bits | AP list | It can include a list of APs (AP or SSID) that are |
| | recom- | suitable for the preference indicated by the STA. |
| | mendation | |

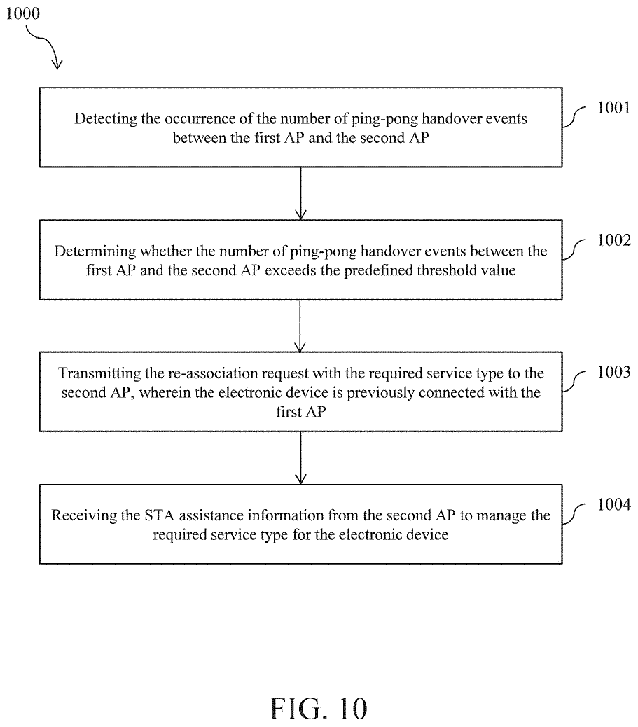

FIG. 10 is a flowchart illustrating example operations (method 1000) performed by the electronic device 500 to handle the ping-pong handover event between the plurality of APs (e.g., AP1 600a and AP2 600b) in the wireless communication network, according to various embodiments.

At operation 1001, the method 1000 includes detecting the occurrence of the number of ping-pong handover events between the first AP 600a and the second AP 600b. At operation 1002, the method 1000 includes determining whether the number of ping-pong handover events between the first AP 600a and the second AP 600b exceeds the defined threshold value. At operation 1003, the method 1000 includes transmitting the re-association request with the required service type to the second AP 600b, where the electronic device 500 is previously connected with the first AP 600a. At operation 1004, the method 1000 includes receiving the STA assistance information from the second AP 600b to manage the required service type for the electronic device 500. A more detailed description related to the various operations of FIG. 10 is covered in the descriptions above related to FIG. 5, FIG. 7, FIG. 8, and FIG. 9, and may not be repeated here for the sake of brevity.

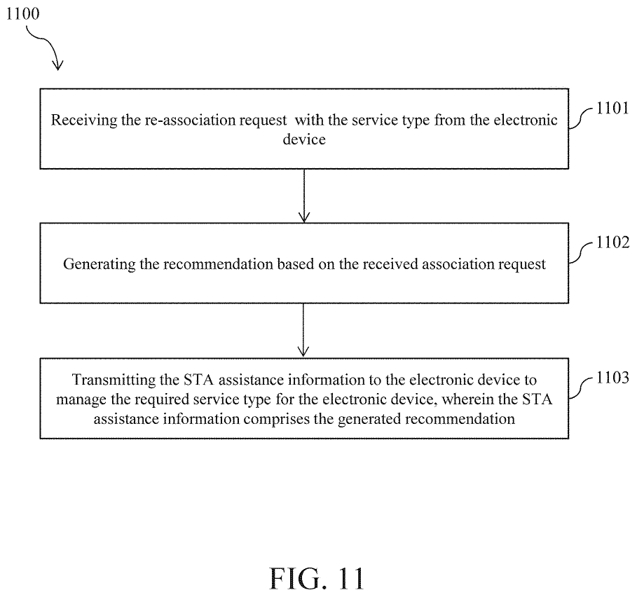

FIG. 11 is a flowchart illustrating example operations (method 1100) performed by the AP 600 to handle the ping-pong handover event, according to various embodiments.

At operation 1101, the method 1100 includes receiving the re-association request from the electronic device 500. At operation 1102, the method 1100 includes generating the recommendation based on the received association request. At operation 1103, the method 1100 includes transmitting the STA assistance information to the electronic device 500 to manage the required service type for the electronic device 500, where the STA assistance information comprises the generated recommendation. A more detailed description related to the various operations of FIG. 11 is covered in the descriptions above related to FIG. 6, FIG. 7, FIG. 8, and FIG. 9, and may not be repeated here for the sake of brevity.

FIG. 12 is a signal flow diagram illustrating an example method 1200 for handling the ping-pong handover event between the plurality of APs (e.g., AP1 600a and AP2 600b) in the wireless communication network, according to various embodiments. The method 1200 may execute multiple operations to handle the ping-pong handover event, which are given below.

In operation 1201, the electronic device 500 (or referred to as “STA”) sends an association request to AP1 600a. Due to temporary blockages, in operations 1202-1203, the electronic device 500 experiences a loss of signal and this triggers a roaming condition in the electronic device 500 and the electronic device 500 scans and finds that the AP2 600b is available, whose signal threshold is lower than the AP1 600a originally, but meets the roaming threshold conditions better at this time. In operation 1204, the AP2 600b receives the re-association request message from the electronic device 500.

In operations 1205-1206, when the temporary blockage is cleared, the electronic device 500 finds that the AP1 600a is better and that triggers the roaming condition and finds the AP1 600a. In operation 1207, the electronic device 500 sends another re-association request message to the AP1 600a. In operations 1208-1209, the electronic device 500 experiences the loss of signal and this triggers the roaming condition in the electronic device 500 and the electronic device 500 scans and finds that the AP2 600b is available, whose signal threshold is lower than the AP1 600a originally, but meets the roaming threshold conditions better at this time. In operation 1210, the AP2 600b receives the re-association request message from the electronic device 500. In operation 1211, the processes (e.g., 1201 to 1210) can repeat N number of times (which can be maintained by the electronic device 500 and can be implementation specific). Once the N times ping-pong is reached, the disclosed method is triggered.

In operation 1212, during this ping-pong or alternatively after N ping-pongs, an event can be triggered in the electronic device 500, like a power save requirement usually due to a low battery. In operation 1213, the electronic device 500 can ask for assistance and inform its requirements, like power save mode, ping pong as cause, etc., by sending the STA assistance request to the AP2 600b. In operation 1214, the AP2 600b may generate the recommendation suitable for this power-saving requirement of the electronic device 500. In operation 1215, the AP2 600b may transmit the STA assistance response to the electronic device 500 to manage the service type event required for the electronic device 500. In other words, the STA assistance response is sent to switch back to the AP1 600a and informs that the AP1 600a is suitable in this context, as it is able to provide more power-saving options and modes. In operation 1216, the electronic device 500 re-associates with AP1 and achieves power save.

In various example embodiments, the STA assistance information message may be defined to be an action frame. Action frames are an extension to existing management frames, and the format for the STA assistance information can be described as below in Table 10. The STA assistance message category value is added to the table of category values, and its associated action frame details are discussed.

TABLE 10

| | | | | Group |
|---|---|---|---|---|
| | | | | addressed |
| Code | Meaning | See Subclause | Robust | privacy |
| 0 | Spectrum | 9.6.2 (Spectrum | Yes | No |
| | management | Management | | |
| | | Action frame | | |
| | | details(#3729)) | | |
| #Chosing | STA | STA assistance | Yes | No |
| value | assistance | information | | |
| between | information | action frame | | |
| <35-125> | | details | | |
| 128-255 | Reserved | NA | NA | NA |

In some example embodiments, the element ID is defined as per Table 11 below.

TABLE 11

| | Element | Element ID | Exten- | Frag- |
|---|---|---|---|---|
| Element | ID | Extension | sible | mentable |
| STA assistance request | 255 | Suitable value | TBD | No |
| (details are present in | | from | | |
| FIG. 13) | | <<137-255>> | | |
| STA assistance response | 255 | Suitable value | TBD | No |
| (details are present in | | from | | |
| FIG. 14) | | <<137-255>> | | |

FIG. 13 illustrates an example STA assistance request message frame structure 1300 (related to operation 1213), according to various embodiments.

In various example embodiments, the STA assistance information comprises a plurality of parameters, the plurality of parameters comprises a category value 1300a, a STA assistance message action value 1300b, and a STA assistance request message element 1300c (STA assistance request message details), for example, as described in Table 12 below.

TABLE 12

| STA assistance | |
|---|---|
| message action value | Meaning |
| 0 | STA assistance request message |
| 1 | STA assistance response message |
| Reserved | |

In various example embodiments, the STA assistance request message element 1300c comprises a plurality of parameters, for example, as described in Table 13 below.

TABLE 13

| Subfield | Definition | Encoding |
|---|---|---|
| Control flag | This subfield defines | 0001: Includes throughput preference |
| (1304 and 1313) | whether the STA | (if 0- no throughput preference) |
| | assistance request shall | 0010: Includes reliability preference |
| | include throughput, | (if 0- no reliability preference) |
| | reliability, low latency, | 0100: Includes low latency preference |
| | power saving preference, | (if 0- no low latency preference) |
| | or not. | 1000: Includes power saving preference |
| | | (if 0- no power saving preference) |
| Throughput | This subfield defines the | The encoding can include one variant: |
| (1305 and 1314) | throughput requirements | 001: Low Throughput, 010: Medium |
| | of the STA. | throughput, 100: High throughput |
| | | In another variant of the solution: |
| | | A few bits to indicate the data rate in Mbps |
| Reliability | This subfield defines the | The encoding can be included in one |
| (1306 and 1315) | reliability preference | variant of the solution: |
| | of the STA. | 001: Low Reliability, 010: Medium |
| | | Reliability, 100: High Reliability |
| | | Other variants of encoding can be to |
| | | indicate the error rate tolerance value. |
| Low latency | This subfield defines the | The encoding can be included in one |
| (1307 and 1316) | low-latency preference | variant of the solution: |
| | of the STA | The value indicates latency tolerance or |
| | | latency requirement in numbers. |
| Power saving | This subfield defines the | The encoding can be included in one |
| (1308 and 1317) | power-saving preference | variant of the solution: |
| | of the STA | 001: Low Power saving, 010: Medium |
| | | power saving, 100: High Power saving |
| | | In another variant of the solution, it can |
| | | indicate the power save category value if |
| | | defined in the specification. |
| Request | This subfield represents the | As per 1309: |
| assistance/request | requirement of STA that it | This can be a one-bit flag. 0-Indicates no |
| assistance flag | needs assistance. | assistance required, 1-indicates |
| (1309 and 1318) | | assistance required. |
| | | As per 1318: |
| | | The Request assistance can be a set of |
| | | bits to indicate whether assistance is |
| | | needed and an indication to tell the |
| | | device's status. For example, when the |
| | | device battery level is low, further |
| | | hysteresis of signal threshold can be |
| | | reduced in recommendation by AP to |
| | | help STA save more batteries. |
| | | Bit 1: 0- Indicates no request for |
| | | Assistance, 1- Indicates a request for |
| | | Assistance. |
| | | Bit 2: 1- Indicates Hysteresis for Signal |
| | | threshold is present in STA preference, |
| | | 0-indicates absence. |
| | | Bit 3: 1- Indicates Delay for roaming |
| | | thresholds to be applied is present, 0- |
| | | indicates absence. |
| Hysteresis - signal | This subfield is present | The encoding can be defined as follows: |
| threshold | in the variant of the | A set of bits can indicate a minimum and |
| (1319) | solution that follows 1319 | maximum range of hysteresis thresholds |
| | implementation, which | tolerable at STA. |
| | represents the minimum | 0 − X bits: Indicate minimum value |
| | and maximum hysteresis | X + 1 − Y bits: Indicate maximum value |
| | thresholds suitable | |
| | for STA. | |
| Delay threshold | This subfield is present | The encoding can be defined as follows: |
| (1320) | in the variant of the | A set of bits can indicate a minimum and |
| | solution that follows 1320 | maximum range of delay thresholds |
| | implementation, which | tolerable at STA. |
| | indicates the minimum | 0 − X bits: Indicate minimum value |
| | and maximum delays | X + 1 − Y bits: Indicate maximum value |
| | suitable for STA. | |

In various example embodiments, the STA assistance request message element 1300c comprises an identity of element 1301, a length of element 1302, an element ID extension 1303, a control flag 1304, a throughput preference 1305, a reliability preference 1306, a low latency preference 1307, a power saving preference 1308, and a request assistance 1309.

In various example embodiments, the STA assistance request message element 1300c comprises the identity of element 1310, the length of element 1311, the element ID extension 1312, the control flag 1313, the throughput preference 1314, the reliability preference 1315, the low latency preference 1316, the power saving preference 1317, a request assistance flag 1318, a hysteresis signal threshold 1319, and a delay threshold 1320.

FIG. 14 is a diagram illustrating an example STA assistance response message frame structure 1400 (related to operation 1215), according to various embodiments.

In various example embodiments, the STA assistance response comprises a plurality of parameters. The plurality of parameters comprises a category value 1400a, a STA assistance information action value 1400b, and a STA assistance response message element 1400c.

In various example embodiments, the STA assistance information action value 1400b indicates a presence or reservation of the STA assistance information.

In various example embodiments, the STA assistance response message element 1400c comprises an identity of element 1401, a length of element 1402, an element ID extension 1403, an assistance information flag 1404, a hysteresis recommendation 1405, a duration recommendation 1406, and an AP recommendation 1407.

In various example embodiments, the assistance information flag 1404 is represented by a set of bits that indicate whether one or more packets comprise a hysteresis signal, a duration, and an AP recommendation, a roaming recommendation, or one or more reserved bits, for example, as described in Table 14 below.

TABLE 14

| Code | Name | Meaning |
|---|---|---|
| Bit 0 | Hysteresis | 0- Hysteresis recommendation present |
| | signal | 1 - Hysteresis recommendation absent |
| Bit 1 | Duration | 0-Duration recommendation present |
| | | 1 - Duration recommendation absent |
| Bit 2 | AP recom- | 0- AP recommendation present |
| | mendation | 1- AP recommendation absent |
| Bit 3 | No roaming | 1 - Do not roam and stay on the current AP |
| Reserved | | |

In various example embodiments, the hysteresis recommendation 1405 indicates a type of hysteresis requirements for the electronic device 500, comprising one of a no hysteresis, a positive hysteresis, and a negative hysteresis, for example, as described in Table 15 below.

TABLE 15

| Code | Name | Meaning |
|---|---|---|
| X Bits | Hysteresis | It can include a value of positive or negative |
| | recom- | hysteresis. To indicate whether there is an early |
| | mendation | or late roaming transition. The details of this |
| | | encoding can be further added in a future IP |
| | | when the solution matures. It can broadly include |
| | | values like: No hysteresis, positive hysteresis, |
| | | or negative hysteresis. |

In various example embodiments, the duration recommendation 1406 indicates whether action is immediate or occurs after a defined time units, as recommended by at least one AP, for example, as described in Table 16 below.

TABLE 16

| Code | Name | Meaning |
|---|---|---|
| X Bits | Duration | It can include encoding such that, duration |
| | recommendation | can be immediate action or after a few Time |
| | | Units as per the recommendation by AP. |

In various example embodiments, the AP recommendation 1407 indicates a list of suitable APs based on one or more preferences indicated by the electronic device 500, for example, as described in Table 17 below.

TABLE 17

| Code | Name | Meaning |
|---|---|---|
| X Bits | AP list | It can include a list of APs (AP or SSID) that are |
| | recom- | suitable for the preference indicated by the STA. |
| | mendation | |

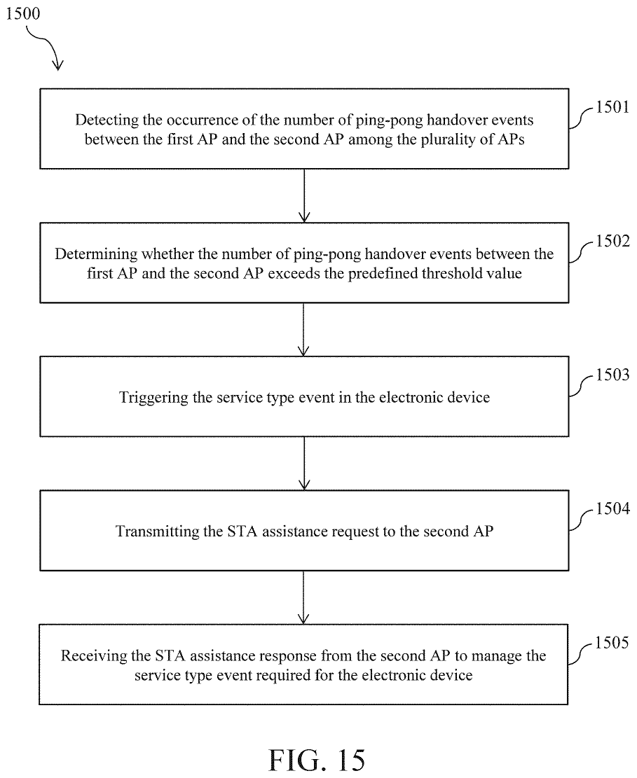

FIG. 15 is a flowchart illustrating example operations (method 1500) performed by the electronic device 500 to handle the ping-pong handover event between the plurality of APs (e.g., AP1 600a and AP2 600b) in the wireless communication network, according to various embodiments.

At operation 1501, the method 1500 includes detecting the occurrence of the number of ping-pong handover events between the first AP 600a and the second AP 600b among the plurality of APs (e.g., AP1 600a and AP2 600b). At operation 1502, the method 1500 includes determining whether the number of ping-pong handover events between the first AP 600a and the second AP 600b exceeds the defined threshold value. At operation 1503, the method 1500 includes triggering the service type event in the electronic device 500. At operation 1504, the method 1500 includes transmitting the STA assistance request to the second AP 600b. At operation 1505, the method 1500 includes receiving the STA assistance response from the second AP 600b to manage the service type event required for the electronic device 500. A more detailed description related to the various operations of FIG. 15 is covered in the descriptions above related to FIG. 5, FIG. 12, FIG. 13, and FIG. 14, and may not be repeated here for the sake of brevity.

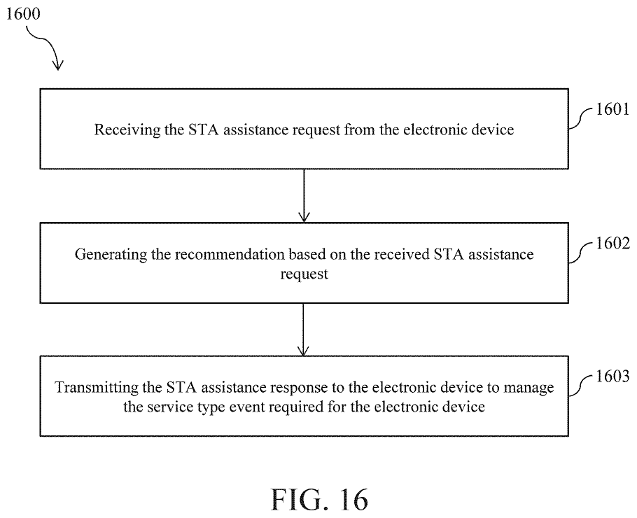

FIG. 16 is a flowchart illustrating example operations (method 1600) performed by the AP 600 to handle the ping-pong handover event, according to various embodiments. At operation 1601, the method 1600 includes receiving the STA assistance request from the electronic device 500. At operation 1602, the method 1600 includes generating the recommendation based on the received STA assistance request. At operation 1603, the method 1600 includes transmitting the STA assistance response to the electronic device 500 to manage the service type event required for the electronic device 500. A more detailed description related to the various operations of FIG. 16 is covered in the descriptions above related to FIG. 6, FIG. 12, FIG. 13, and FIG. 14, and may not be repeated here for the sake of brevity.

In various example embodiments, the disclosed method has several advantages over the existing method, which are stated below.
a. Improved connectivity: The disclosed method reduces disruptions caused by frequent switching (ping-ponging) between the APs (e.g., AP1 600a and AP2 600b), ensuring a more stable connection for users.
b. Efficient resource management: By monitoring the number of handover events and setting the threshold (e.g., defined threshold value), the disclosed method may intelligently manage network resources, preventing/reducing unnecessary load on the APs (e.g., AP1 600a and AP2 600b).
c. Tailored service delivery: The inclusion of service type indications in the re-association requests and/or STA assistance requests allows the network to provide customized assistance based on the specific needs of the electronic device 500, enhancing user experience.
d. Proactive assistance: The disclosed method for transmitting the STA assistance information and/or STA assistance response enables the second AP 600b to offer recommendations that help optimize the connection, improving overall service quality.
e. Reduced latency: By streamlining the handover process and reducing the need for repeated reconnections, the disclosed method minimizes/reduces latency, which is crucial for time-sensitive applications like video streaming or gaming.
f. Enhanced user experience: With better management of handover events and tailored support, users experience fewer interruptions and better service continuity, leading to higher satisfaction.
g. Network efficiency: The disclosed method helps in balancing the load among multiple APs (e.g., AP1 600a and AP2 600b), enhancing the overall efficiency of the wireless network and improving performance for all users.
h. Scalability: As the number of devices in the network grows, this disclosed method can effectively manage handover events, making it suitable for larger networks with many APs (e.g., AP1 600a and AP2 600b).

An example embodiment of the present disclosure provides an electronic device (500). The electronic device (500) may be a station (STA). The electronic device (500) comprises at least one processor (520) including processing circuitry. The electronic device (500) comprises memory (510) storing instructions that, when executed by the at least one processor (520) individually or collectively, cause the electronic device (500) to determine a number of ping-pong handover events between a first AP (600a) and a second AP (600b). The instructions, when executed by the at least one processor (520) individually or collectively, cause the electronic device (500) to determine whether the number of ping-pong handover events between the first AP (600a) and the second AP (600b) exceeds a defined threshold. The instructions, when executed by the at least one processor (520) individually or collectively, cause the electronic device (500) to, in response to determining that the number of the ping-pong handover events between the first AP (600a) and the second AP (600b) exceeds the defined threshold, transmit a re-association request to the second AP (600b) with the required service type, wherein the electronic device (500) is previously connected with the first AP (600a). The re-association request comprises an indication of a required service type for the electronic device (500) and a flag indicating a requirement for assistance for the electronic device (500).

In various example embodiments, the instructions, when executed by the at least one processor (520) individually or collectively, cause the electronic device (500) to receive a station (STA) assistance information from the second AP (600b), wherein the station (STA) assistance information includes information to manage the required service type for the electronic device (500).

In various example embodiments, the instructions, when executed by the at least one processor (520) individually or collectively, cause the electronic device (500) to transmit an association request to the first AP (600a) to establish a first communication channel between the electronic device (500) and the first AP (600a), wherein the association request comprises an indication of the required service type for the electronic device (500). The instructions, when executed by the at least one processor (520) individually or collectively, cause the electronic device (500) to detect a temporary signal blockage associated with the first established communication channel. The instructions, when executed by the at least one processor (520) individually or collectively, cause the electronic device (500) to, in response to detecting that the temporary blockage, identify the second AP (600b) to establish a second communication channel between the electronic device (500) and the second AP (600b), wherein a signal quality or signal strength associated with the second established communication channel is superior to the first established communication channel. The instructions, when executed by the at least one processor (520) individually or collectively, cause the electronic device (500) to transmit the re-association request to the identified second AP (600b). The instructions, when executed by the at least one processor (520) individually or collectively, cause the electronic device (500) to detect that the temporary blockage has cleared, wherein a signal quality or signal strength associated with the first established communication channel is superior to the second established communication channel. The instructions, when executed by the at least one processor (520) individually or collectively, cause the electronic device (500) to, in response to detecting that the temporary blockage has cleared, transmit the re-association request along with the required service type indication to the first AP (600a).

In various example embodiments, the re-association request and the association request comprise a station (STA) assistance information to provide the indication of the required service type for the electronic device (500).

In various example embodiments, the station (STA) assistance information comprises a plurality of parameters. The plurality of parameters comprises one or more of an identity of element, a length of element, an element ID extension, a control flag, and at least one required service type, the at least one service type comprising a throughput preference, a reliability preference, a low latency preference, a power saving preference, and a request assistance flag.

In various example embodiments, the station (STA) assistance information comprises a plurality of parameters. The plurality of parameters comprises one or more of an identity of element, a length of element, an element ID extension, a control flag, and at least one required service type. The at least one service type comprises one or more of a throughput preference, a reliability preference, a low latency preference, a power saving preference, and a request assistance flag, a hysteresis signal threshold, and a delay threshold.

In various example embodiments, the plurality of parameters comprises an identity of element, a length of element, an element ID extension, a control flag, and at least one required service type. The at least one service type comprises a throughput preference, a reliability preference, a low latency preference, a power saving preference, and a request assistance flag.

In various example embodiments, the control flag indicates whether the station (STA) assistance information comprises one of a plurality of throughput preference, reliability preference, low latency preference, and power saving preference.

In various example embodiments, the throughput preference indicates a type of throughput requirements for the electronic device (500), comprising one of a low throughput, a medium throughput, and a high throughput, and the throughput represented by one or more bits indicating data rates.

In various example embodiments, the reliability preference indicates a type of reliability requirements for the electronic device (500), comprising one of a low reliability, a medium reliability, and a high reliability, and the reliability represented by an error rate tolerance value.

In various example embodiments, the low latency preference is represented by a value indicating latency tolerance or latency requirement in numbers.

In various example embodiments, the power saving preference indicates a type of power saving requirements for the electronic device (500) comprising a low power saving, a medium power saving, and a high power saving, and the power saving preference is represented by a power save category value.

In various example embodiments, the request assistance and the request assistance flag indicate whether the electronic device (500) requires assistance, and the request assistance and the request assistance flag are represented by a set of bits that indicate whether assistance is needed and a device status.

In various example embodiments, the hysteresis signal threshold indicates minimum and maximum hysteresis thresholds suitable for the electronic device (500).

In various example embodiments, the hysteresis threshold is a signal threshold value that indicates by at least one AP to the electronic device (500) to add an offset to the electronic device (500)-implemented-threshold values for roaming, and the hysteresis signal threshold is represented by a set of bits that indicate a minimum and maximum range of hysteresis thresholds tolerable at the electronic device (500).

In various example embodiments, the delay threshold indicates minimum and maximum delays suitable for the electronic device (500).

In various example embodiments, the delay threshold is represented as a time interval that the electronic device (500) waits, after a roaming condition occurs as per device implementation, before the electronic device (500) triggers a roaming, and the delay threshold is represented by a set of bits that indicate a minimum and maximum range of delay thresholds that are tolerable at the electronic device (500).

In various example embodiments, the received STA assistance information at the electronic device (500) comprises a plurality of parameters. The plurality of parameters comprises a category value, a STA assistance information action value, an assistance information flag, a hysteresis recommendation, a duration recommendation, and an AP recommendation.

In various example embodiments, the STA assistance information action value indicates a presence or reservation of the STA assistance information.

In various example embodiments, the assistance information flag is represented by a set of bits that indicate whether one or more packets comprise a hysteresis signal, a duration, and an AP recommendation, a roaming recommendation, or one or more reserved bits.

In various example embodiments, the hysteresis recommendation indicates a type of hysteresis requirements for the electronic device (500), comprising one of a no hysteresis, a positive hysteresis, and a negative hysteresis.

In various example embodiments, the duration recommendation indicates whether action is immediate or occurs after a defined time unit, as recommended by at least one second AP (600b).

In various example embodiments, the AP recommendation indicates a list of suitable APs based on one or more preferences indicated by the electronic device (500).

An example embodiment of the present disclosure provides an electronic device (500). The electronic device (500) may be a station (STA). The electronic device (500) comprises at least one processor (520) including processing circuitry. The electronic device (500) comprises memory (510) storing instructions that, when executed by the at least one processor (520) individually or collectively, cause the electronic device (500) to determine a number of ping-pong handover events between a first AP (600a) and a second AP (600b). The instructions, when executed by the at least one processor (520) individually or collectively, cause the electronic device (500) to determine whether the number of ping-pong handover events between the first AP (600a) and the second AP (600b) exceeds a defined threshold. The instructions, when executed by the at least one processor (520) individually or collectively, cause the electronic device (500) to, in response to determining that the number of the ping-pong handover events between the first AP (600a) and the second AP (600b) exceeds the defined threshold value, trigger a service type event in the electronic device (500), wherein the service type event comprises one or more of a power saving event, a throughput event, a latency event, and a reliability event. The instructions, when executed by the at least one processor (520) individually or collectively, cause the electronic device (500) to, in response to triggering the service type event, transmit a station (STA) assistance request to the second AP (600b), wherein the electronic device (500) is previously connected with the first AP (600a), wherein the station (STA) assistance request comprises an indication of a service type event required for the electronic device (500) and a ping-pong flag indicating a requirement for assistance for the electronic device (500).

In various example embodiments, the instructions, when executed by the at least one processor (520) individually or collectively, cause the electronic device (500) to receive a station (STA) assistance information from the second AP (600b), wherein the station (STA) assistance information includes information to manage the required service type for the electronic device (500).

In various example embodiments, the STA assistance response indicates a preferable AP among the plurality of APs for the service type event.

In various example embodiments, prior to detecting the ping-pong handover events between the first AP (600a) and the second AP (600b), the instructions, when executed by the at least one processor (520) individually or collectively, cause the electronic device (500) to: transmit an association request to the first AP (600a) to establish a first communication channel between the electronic device (500) and the first AP (600a); detect a temporary signal blockage associated with the first established communication channel; in response to detecting that the temporary blockage, identify the second AP (600b) to establish a second communication channel between the electronic device (500) and the second AP (600b), wherein a signal quality or signal strength associated with the second established communication channel is superior to the first established communication channel; transmit a re-association request to the identified second AP (600b); detect that the temporary blockage has cleared, wherein a signal quality or signal strength associated with the first established communication channel is superior to the second established communication channel; and, in response to detecting that the temporary blockage has cleared, transmit the re-association request along with the indication to the first AP (600a).

In various example embodiments, the station (STA) assistance request comprises a plurality of parameters. The plurality of parameters comprises a category value, a STA Assistance Message Action value, and a STA assistance request message element.

In various example embodiments, the station (STA) assistance information comprises a plurality of parameters. The plurality of parameters comprises one or more of an identity of element, a length of element, an element ID extension, a control flag, and at least one required service type. The at least one service type comprises one or more of a throughput preference, a reliability preference, a low latency preference, a power saving preference, and a request assistance flag, a hysteresis signal threshold, and a delay threshold.

In various example embodiments, the plurality of parameters comprises an identity of element, a length of element, an element ID extension, a control flag, and at least one required service type. The at least one service type comprises a throughput preference, a reliability preference, a low latency preference, a power saving preference, and a request assistance flag.

In various example embodiments, the control flag indicates whether the STA assistance information comprises the throughput preference, the reliability preference, the low latency preference, and the power saving preference.

In various example embodiments, the throughput preference indicates a type of throughput requirements for the electronic device (500), comprising one of a low throughput, a medium throughput, and a high throughput, and the throughput represented by one or more bits indicating data rates.

In various example embodiments, the reliability preference indicates a type of reliability requirements for the electronic device (500), comprising one of a low reliability, a medium reliability, and a high reliability, and the reliability represented by an error rate tolerance value.

In various example embodiments, the low latency preference is represented by a value indicating latency tolerance or latency requirement in numbers.

In various example embodiments, the power saving preference indicates a type of power saving requirements for the electronic device (500), comprising a low power saving, a medium power saving, and a high power saving, and the power saving preference is represented by a power save category value.

In various example embodiments, the request assistance and the request assistance flag indicate whether the electronic device (500) requires assistance, and the request assistance and the request assistance flag are represented by a set of bits that indicate whether assistance is needed and a device status.

In various example embodiments, the hysteresis signal threshold indicates minimum and maximum hysteresis thresholds suitable for the electronic device (500).

In various example embodiments, the hysteresis threshold is a signal threshold value that indicates by at least one AP to the electronic device (500) to add an offset to the electronic device (500)-implemented-threshold values for roaming, and the hysteresis signal threshold is represented by a set of bits that indicate a minimum and maximum range of hysteresis thresholds tolerable at the electronic device (500).

In various example embodiments, the delay threshold indicates minimum and maximum delays suitable for the electronic device (500).

In various example embodiments, the delay threshold is represented as a time interval that the electronic device (500) waits, after a roaming condition occurs as per device implementation, before the electronic device (500) triggers a roaming, and the delay threshold is represented by a set of bits that indicate a minimum and maximum range of delay thresholds that are tolerable at the electronic device (500).

In various example embodiments, the STA assistance response comprises a plurality of parameters. The plurality of parameters comprises a category value, a STA assistance information action value, and a STA assistance response message element. The STA assistance response message element comprises an identity of element, a length of element, an element ID extension, an assistance information flag, a hysteresis recommendation, a duration recommendation, and an AP recommendation.

In various example embodiments, the STA assistance information action value indicates a presence or reservation of the STA assistance information. The assistance information flag is represented by a set of bits that indicate whether one or more packets comprise a hysteresis signal, a duration, and an AP recommendation, a roaming recommendation, or one or more reserved bits. The hysteresis recommendation indicates a type of hysteresis requirements for the electronic device (500), comprising one of a no hysteresis, a positive hysteresis, and a negative hysteresis. The duration recommendation indicates whether action is immediate or occurs after a defined time unit, as recommended by at least one AP. The AP recommendation indicates a list of suitable APs based on one or more preferences indicated by the electronic device (500).

An example embodiment of the present disclosure provides a second access point (AP) (600, 600b). The second AP (600, 600b) comprises at least one processor (620) including processing circuitry. The second AP (600, 600b) comprises memory (610) storing instructions that, when executed by the at least one processor (620) individually or collectively, cause the second AP (600, 600b) to receive a re-association request from an electronic device (500), wherein the electronic device (500) is previously connected with a first AP (600a). The re-association request comprises an indication of a required service type for the electronic device (500) and a flag indicating a requirement for assistance for the electronic device (500). The instructions, when executed by the at least one processor (620) individually or collectively, cause the second AP (600, 600b) to generate a recommendation based on the received STA assistance request. The instructions, when executed by the at least one processor (620) individually or collectively, cause the second AP (600) to transmit a station (STA) assistance information to the electronic device (500) to manage the required service type for the electronic device (500), wherein the STA assistance information comprises the generated recommendation.

An example embodiment of the present disclosure provides a second access point (AP) (600, 600b). The second AP (600, 600b) comprises at least one processor (620) including processing circuitry. The second AP (600) comprises memory (610) storing instructions that, when executed by the at least one processor (620) individually or collectively, cause the second AP (600) to receive a station (STA) assistance request from an electronic device (500), wherein the electronic device (500) is previously connected with a first AP (600a). A service type event is triggered at the electronic device (500) due to a number of ping-pong handover events between the first AP (600a) and the second AP (600b) exceeding a defined threshold. The STA assistance request comprises an indication of a service type event required for the electronic device (500), and a ping-pong flag indicating a requirement for assistance for the electronic device (500). The instructions, when executed by the at least one processor (620) individually or collectively, cause the second AP (600) to generate a recommendation based on the received STA assistance request. The instructions, when executed by the at least one processor (620) individually or collectively, cause the second AP (600) to transmit a STA assistance response to the electronic device (500) to manage the service type event required for the electronic device (500). The STA assistance response comprises the generated recommendation.

An example embodiment of the present disclosure provides a method for wireless communication performed by an electronic device (500). The method comprises determining a number of ping-pong handover events between a first AP (600a) and a second AP (600b). The method comprises determining whether the number of ping-pong handover events between the first AP (600a) and the second AP (600b) exceeds a defined threshold. The method comprises, in response to determining that the number of the ping-pong handover events between the first AP (600a) and the second AP (600b) exceeds the defined threshold, transmitting a re-association request to the second AP (600b) with the required service type, wherein the electronic device (500) is previously connected with the first AP (600a). The re-association request comprises an indication of a required service type for the electronic device (500) and a flag indicating a requirement for assistance for the electronic device (500).

In various example embodiments, the method comprises receiving a station (STA) assistance information from the second AP (600b), wherein the station (STA) assistance information includes information to manage the required service type for the electronic device (500).

In various example embodiments, the method comprises transmitting an association request to the first AP (600a) to establish a first communication channel between the electronic device (500) and the first AP (600a), wherein the association request comprises an indication of the required service type for the electronic device (500). The method comprises detecting a temporary signal blockage associated with the first established communication channel. The method comprises, in response to detecting that the temporary blockage, identifying the second AP (600b) to establish a second communication channel between the electronic device (500) and the second AP (600b), wherein a signal quality or signal strength associated with the second established communication channel is superior to the first established communication channel. The method comprises transmitting the re-association request to the identified second AP (600b). The method comprises detecting that the temporary blockage has cleared, wherein a signal quality or signal strength associated with the first established communication channel is superior to the second established communication channel. The method comprises, in response to detecting that the temporary blockage has cleared, transmit the re-association request along with the required service type indication to the first AP (600a).

In various example embodiments, the re-association request and the association request comprise a station (STA) assistance information to provide the indication of the required service type for the electronic device (500).

In various example embodiments, the station (STA) assistance information comprises a plurality of parameters. The plurality of parameters comprises one or more of an identity of element, a length of element, an element ID extension, a control flag, and at least one required service type, the at least one service type comprising a throughput preference, a reliability preference, a low latency preference, a power saving preference, and a request assistance flag.

In various example embodiments, the station (STA) assistance information comprises a plurality of parameters. The plurality of parameters comprises one or more of an identity of element, a length of element, an element ID extension, a control flag, and at least one required service type. The at least one service type comprises one or more of a throughput preference, a reliability preference, a low latency preference, a power saving preference, and a request assistance flag, a hysteresis signal threshold, and a delay threshold.

In various example embodiments, the plurality of parameters comprises an identity of element, a length of element, an element ID extension, a control flag, and at least one required service type. The at least one service type comprises a throughput preference, a reliability preference, a low latency preference, a power saving preference, and a request assistance flag.

In various example embodiments, the control flag indicates whether the station (STA) assistance information comprises one of a plurality of throughput preference, reliability preference, low latency preference, and power saving preference.

In various example embodiments, the throughput preference indicates a type of throughput requirements for the electronic device (500), comprising one of a low throughput, a medium throughput, and a high throughput, and the throughput represented by one or more bits indicating data rates.

In various example embodiments, the reliability preference indicates a type of reliability requirements for the electronic device (500), comprising one of a low reliability, a medium reliability, and a high reliability, and the reliability represented by an error rate tolerance value.

In various example embodiments, the low latency preference is represented by a value indicating latency tolerance or latency requirement in numbers.

In various example embodiments, the power saving preference indicates a type of power saving requirements for the electronic device (500) comprising a low power saving, a medium power saving, and a high power saving, and the power saving preference is represented by a power save category value.

In various example embodiments, the request assistance and the request assistance flag indicate whether the electronic device (500) requires assistance, and the request assistance and the request assistance flag are represented by a set of bits that indicate whether assistance is needed and a device status.

In various example embodiments, the hysteresis signal threshold indicates minimum and maximum hysteresis thresholds suitable for the electronic device (500).

In various example embodiments, the hysteresis threshold is a signal threshold value that indicates by at least one AP to the electronic device (500) to add an offset to the electronic device (500)-implemented-threshold values for roaming, and the hysteresis signal threshold is represented by a set of bits that indicate a minimum and maximum range of hysteresis thresholds tolerable at the electronic device (500).

In various example embodiments, the delay threshold indicates minimum and maximum delays suitable for the electronic device (500).

In various example embodiments, the delay threshold is represented as a time interval that the electronic device (500) waits, after a roaming condition occurs as per device implementation, before the electronic device (500) triggers a roaming, and the delay threshold is represented by a set of bits that indicate a minimum and maximum range of delay thresholds that are tolerable at the electronic device (500).

In various example embodiments, the received STA assistance information at the electronic device (500) comprises a plurality of parameters. The plurality of parameters comprises a category value, a STA assistance information action value, an assistance information flag, a hysteresis recommendation, a duration recommendation, and an AP recommendation.

In various example embodiments, the STA assistance information action value indicates a presence or reservation of the STA assistance information.

In various example embodiments, the assistance information flag is represented by a set of bits that indicate whether one or more packets comprise a hysteresis signal, a duration, and an AP recommendation, a roaming recommendation, or one or more reserved bits.

In various example embodiments, the hysteresis recommendation indicates a type of hysteresis requirements for the electronic device (500), comprising one of a no hysteresis, a positive hysteresis, and a negative hysteresis.

In various example embodiments, the duration recommendation indicates whether action is immediate or occurs after a defined time unit, as recommended by at least one second AP (600b).

In various example embodiments, the AP recommendation indicates a list of suitable APs based on one or more preferences indicated by the electronic device (500).

An example embodiment of the present disclosure provides a method performed by an electronic device (500). The method comprises determining a number of ping-pong handover events between a first AP (600a) and a second AP (600b). The method comprises determining whether the number of ping-pong handover events between the first AP (600a) and the second AP (600b) exceeds a defined threshold. The method comprises, in response to determining that the number of the ping-pong handover events between the first AP (600a) and the second AP (600b) exceeds the defined threshold value, trigger a service type event in the electronic device (500), wherein the service type event comprises one or more of a power saving event, a throughput event, a latency event, and a reliability event. The method comprises, in response to triggering the service type event, transmit a station (STA) assistance request to the second AP (600b), wherein the electronic device (500) is previously connected with the first AP (600a), wherein the station (STA) assistance request comprises an indication of a service type event required for the electronic device (500) and a ping-pong flag indicating a requirement for assistance for the electronic device (500).

In various example embodiments, the method comprises receiving a station (STA) assistance information from the second AP (600b), wherein the station (STA) assistance information includes information to manage the required service type for the electronic device (500).

In various example embodiments, the STA assistance response indicates a preferable AP among the plurality of APs for the service type event.

In various example embodiments, prior to detecting the ping-pong handover events between the first AP (600a) and the second AP (600b), the method comprises transmitting an association request to the first AP (600a) to establish a first communication channel between the electronic device (500) and the first AP (600a). The method comprises detecting a temporary signal blockage associated with the first established communication channel, The method comprises, in response to detecting that the temporary blockage, identifying the second AP (600b) to establish a second communication channel between the electronic device (500) and the second AP (600b), wherein a signal quality or signal strength associated with the second established communication channel is superior to the first established communication channel. The method comprises transmitting a re-association request to the identified second AP (600b). The method comprises detecting that the temporary blockage has cleared, wherein a signal quality or signal strength associated with the first established communication channel is superior to the second established communication channel. The method comprises, in response to detecting that the temporary blockage has cleared, transmitting the re-association request along with the indication to the first AP (600a).

In various example embodiments, the station (STA) assistance request comprises a plurality of parameters. The plurality of parameters comprises a category value, a STA Assistance Message Action value, and a STA assistance request message element.

In various example embodiments, the station (STA) assistance information comprises a plurality of parameters. The plurality of parameters comprises one or more of an identity of element, a length of element, an element ID extension, a control flag, and at least one required service type. The at least one service type comprises one or more of a throughput preference, a reliability preference, a low latency preference, a power saving preference, and a request assistance flag, a hysteresis signal threshold, and a delay threshold.

In various example embodiments, the plurality of parameters comprises an identity of element, a length of element, an element ID extension, a control flag, and at least one required service type. The at least one service type comprises a throughput preference, a reliability preference, a low latency preference, a power saving preference, and a request assistance flag.

In various example embodiments, the control flag indicates whether the STA assistance information comprises the throughput preference, the reliability preference, the low latency preference, and the power saving preference.

In various example embodiments, the throughput preference indicates a type of throughput requirements for the electronic device (500), comprising one of a low throughput, a medium throughput, and a high throughput, and the throughput represented by one or more bits indicating data rates.

In various example embodiments, the reliability preference indicates a type of reliability requirements for the electronic device (500), comprising one of a low reliability, a medium reliability, and a high reliability, and the reliability represented by an error rate tolerance value.

In various example embodiments, the low latency preference is represented by a value indicating latency tolerance or latency requirement in numbers.

In various example embodiments, the power saving preference indicates a type of power saving requirements for the electronic device (500), comprising a low power saving, a medium power saving, and a high power saving, and the power saving preference is represented by a power save category value.

In various example embodiments, the request assistance and the request assistance flag indicate whether the electronic device (500) requires assistance, and the request assistance and the request assistance flag are represented by a set of bits that indicate whether assistance is needed and a device status.

In various example embodiments, the hysteresis signal threshold indicates minimum and maximum hysteresis thresholds suitable for the electronic device (500).

In various example embodiments, the hysteresis threshold is a signal threshold value that indicates by at least one AP to the electronic device (500) to add an offset to the electronic device (500)-implemented-threshold values for roaming, and the hysteresis signal threshold is represented by a set of bits that indicate a minimum and maximum range of hysteresis thresholds tolerable at the electronic device (500).

In various example embodiments, the delay threshold indicates minimum and maximum delays suitable for the electronic device (500).

In various example embodiments, the delay threshold is represented as a time interval that the electronic device (500) waits, after a roaming condition occurs as per device implementation, before the electronic device (500) triggers a roaming, and the delay threshold is represented by a set of bits that indicate a minimum and maximum range of delay thresholds that are tolerable at the electronic device (500).

In various example embodiments, the STA assistance response comprises a plurality of parameters. The plurality of parameters comprises a category value, a STA assistance information action value, and a STA assistance response message element. The STA assistance response message element comprises an identity of element, a length of element, an element ID extension, an assistance information flag, a hysteresis recommendation, a duration recommendation, and an AP recommendation.

In various example embodiments, the STA assistance information action value indicates a presence or reservation of the STA assistance information. The assistance information flag is represented by a set of bits that indicate whether one or more packets comprise a hysteresis signal, a duration, and an AP recommendation, a roaming recommendation, or one or more reserved bits. The hysteresis recommendation indicates a type of hysteresis requirements for the electronic device (500), comprising one of a no hysteresis, a positive hysteresis, and a negative hysteresis. The duration recommendation indicates whether action is immediate or occurs after a defined time unit, as recommended by at least one AP. The AP recommendation indicates a list of suitable APs based on one or more preferences indicated by the electronic device (500).

An example embodiment of the present disclosure provides a method performed by a second access point (AP) (600, 600b). The method comprises receiving a re-association request from an electronic device (500), wherein the electronic device (500) is previously connected with a first AP (600a). The re-association request comprises an indication of a required service type for the electronic device (500) and a flag indicating a requirement for assistance for the electronic device (500). The method comprises generating a recommendation based on the received STA assistance request. The method comprises transmitting a station (STA) assistance information to the electronic device (500) to manage the required service type for the electronic device (500), wherein the STA assistance information comprises the generated recommendation.

An example embodiment of the present disclosure provides a method performed by a second access point (AP) (600, 600b). The method comprises receiving a station (STA) assistance request from an electronic device (500), wherein the electronic device (500) is previously connected with a first AP (600a). A service type event is triggered at the electronic device (500) due to a number of ping-pong handover events between the first AP (600a) and the second AP (600b) exceeding a defined threshold. The STA assistance request comprises an indication of a service type event required for the electronic device (500), and a ping-pong flag indicating a requirement for assistance for the electronic device (500). The method comprises generating a recommendation based on the received STA assistance request. The method comprises transmitting a STA assistance response to the electronic device (500) to manage the service type event required for the electronic device (500). The STA assistance response comprises the generated recommendation.

An example embodiment of the present disclosure provides a non-transitory computer-readable storage medium. The methods disclosed herein can be performed by one or more computer programs stored on the non-transitory computer-readable storage.

An example embodiment of the present disclosure provides a non-statutory computer-readable storage medium storing one or more computer programs comprising instructions to perform a method for wireless communication performed by an electronic device. The method comprises determining a number of ping-pong handover events between a first AP (600a) and a second AP (600b). The method comprises determining whether the number of ping-pong handover events between the first AP (600a) and the second AP (600b) exceeds a defined threshold. The method comprises, in response to determining that the number of the ping-pong handover events between the first AP (600a) and the second AP (600b) exceeds the defined threshold, transmitting a re-association request to the second AP (600b) with the required service type, wherein the electronic device (500) is previously connected with the first AP (600a). The re-association request comprises an indication of a required service type for the electronic device (500) and a flag indicating a requirement for assistance for the electronic device (500).

An example embodiment of the present disclosure provides a non-statutory computer-readable storage medium storing one or more computer programs comprising instructions to perform a method for wireless communication performed by an electronic device. The method comprises determining whether the number of ping-pong handover events between the first AP (600a) and the second AP (600b) exceeds a defined threshold. The method comprises, in response to determining that the number of the ping-pong handover events between the first AP (600a) and the second AP (600b) exceeds the defined threshold value, trigger a service type event in the electronic device (500), wherein the service type event comprises one or more of a power saving event, a throughput event, a latency event, and a reliability event. The method comprises, in response to triggering the service type event, transmit a station (STA) assistance request to the second AP (600b), wherein the electronic device (500) is previously connected with the first AP (600a), wherein the station (STA) assistance request comprises an indication of a service type event required for the electronic device (500) and a ping-pong flag indicating a requirement for assistance for the electronic device (500).

An example embodiment of the present disclosure provides a non-statutory computer-readable storage medium storing one or more computer programs comprising instructions to perform a method for wireless communication performed by a second access point (AP). The method comprises receiving a re-association request from an electronic device (500), wherein the electronic device (500) is previously connected with a first AP (600a). The re-association request comprises an indication of a required service type for the electronic device (500) and a flag indicating a requirement for assistance for the electronic device (500). The method comprises generating a recommendation based on the received STA assistance request. The method comprises transmitting a station (STA) assistance information to the electronic device (500) to manage the required service type for the electronic device (500), wherein the STA assistance information comprises the generated recommendation.

An example embodiment of the present disclosure provides a non-statutory computer-readable storage medium storing one or more computer programs comprising instructions to perform a method for wireless communication performed by a second access point (AP). The method comprises receiving a station (STA) assistance request from an electronic device (500), wherein the electronic device (500) is previously connected with a first AP (600a). A service type event is triggered at the electronic device (500) due to a number of ping-pong handover events between the first AP (600a) and the second AP (600b) exceeding a defined threshold. The STA assistance request comprises an indication of a service type event required for the electronic device (500), and a ping-pong flag indicating a requirement for assistance for the electronic device (500). The method comprises generating a recommendation based on the received STA assistance request. The method comprises transmitting a STA assistance response to the electronic device (500) to manage the service type event required for the electronic device (500). The STA assistance response comprises the generated recommendation.

The various actions, acts, blocks, steps, operations, or the like in the diagrams may be performed in the order presented, in a different order, or simultaneously. Further, in various embodiments, some of the actions, acts, blocks, steps, or the like may be omitted, added, modified, skipped, or the like without departing from the scope of the disclosure.

Unless otherwise defined, technical and scientific terms used herein have the same meaning as commonly understood by one ordinary skilled in the art to which this disclosure belongs. The system, methods, and examples provided herein are illustrative only and not intended to be limiting.

The “processor” herein includes processing circuitry, and/or may include multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

While specific language has been used to describe the present subject matter, any limitations arising on account thereof, are not intended. As would be apparent to one skilled in the art, various working modifications may be made to the method to implement the disclosure as taught herein. The drawings and the forgoing description give examples of embodiments. Those skilled in the art will appreciate that one or more of the described elements may well be combined into a single functional element. Certain elements may be split into multiple functional elements. Elements from one embodiment may be added to another embodiment.

The various example embodiments disclosed herein can be implemented using at least one hardware device and performing network management functions to control the elements.

What is claimed is:

1. An electronic device comprising:
at least one processor comprising processing circuitry; and
memory storing instructions, wherein at least one processor, individually or collectively, is configured to execute the instructions and to cause the electronic device to:
determine a number of ping-pong handover events between a first access point (AP) and a second AP;
determine whether the number of ping-pong handover events between the first AP and the second AP exceeds a defined threshold; and
in response to determining that the number of the ping-pong handover events between the first AP and the second AP exceeds the defined threshold, transmit a re-association request to the second AP with a required service type, wherein the electronic device is previously connected with the first AP, wherein the re-association request comprises an indication of a required service type for the electronic device and a flag indicating a requirement for assistance for the electronic device.

2. The electronic device of claim 1, wherein at least one processor, individually or collectively, is configured to cause the electronic device to:
receive a station (STA) assistance information from the second AP, wherein the station (STA) assistance information includes information for managing the required service type for the electronic device.

3. The electronic device of claim 1, wherein at least one processor, individually or collectively, is configured to cause the electronic device to:
transmit an association request to the first AP to establish a first communication channel between the electronic device and the first AP, wherein the association request comprises an indication of the required service type for the electronic device;
detect a temporary signal blockage associated with the first established communication channel;
in response to detecting a temporary blockage, identify the second AP to establish a second communication channel between the electronic device and the second AP, wherein a signal quality or signal strength associated with the second established communication channel is superior to the first established communication channel;
transmit the re-association request to the identified second AP,
detect that the temporary blockage has cleared, wherein a signal quality or signal strength associated with the first established communication channel is superior to the second established communication channel; and
in response to detecting that the temporary blockage has cleared, transmit the re-association request along with the required service type indication to the first AP.

4. The electronic device of claim 1, wherein the re-association request and the association request comprise a station (STA) assistance information to provide the indication of the required service type for the electronic device.

5. The electronic device of claim 2, wherein the station (STA) assistance information comprises a plurality of parameters,
wherein the plurality of parameters comprises at least one of an identity of element, a length of element, an element ID extension, a control flag, and at least one required service type,
wherein the at least one service type comprises at least one of a throughput preference, a reliability preference, a low latency preference, a power saving preference, and a request assistance flag, a hysteresis signal threshold, and a delay threshold.

6. The electronic device of claim 5,
wherein the plurality of parameters comprises an identity of element, a length of element, an element ID extension, a control flag, and at least one required service type,
wherein the at least one service type comprises a throughput preference, a reliability preference, a low latency preference, a power saving preference, and a request assistance flag.

7. The electronic device of claim 5,
wherein the control flag indicates whether the station (STA) assistance information comprises one of a plurality of throughput preference, reliability preference, low latency preference, and power saving preference;
wherein the throughput preference indicates a type of throughput requirements for the electronic device, comprising one of a low throughput, a medium throughput, and a high throughput, and the throughput represented by one or more bits indicating data rates;
wherein the reliability preference indicates a type of reliability requirements for the electronic device, comprising one of a low reliability, a medium reliability, and a high reliability, and the reliability represented by an error rate tolerance value;
wherein the low latency preference is represented by a value indicating latency tolerance or latency requirement in numbers;
wherein the power saving preference indicates a type of power saving requirements for the electronic device comprising a low power saving, a medium power saving, and a high power saving, and the power saving preference is represented by a power save category value;
wherein the request assistance and the request assistance flag indicate whether the electronic device requires assistance, and the request assistance and the request assistance flag are represented by a set of bits that indicate whether assistance is needed and a device status;
wherein the hysteresis signal threshold indicates minimum and maximum hysteresis thresholds suitable for the electronic device,
wherein the hysteresis threshold includes a signal threshold value indicating at least one AP to the electronic device to add an offset to the electronic device-implemented-threshold values for roaming, and the hysteresis signal threshold is represented by a set of bits indicating a minimum and maximum range of hysteresis thresholds tolerable at the electronic device;
wherein the delay threshold indicates minimum and maximum delays suitable for the electronic device; and
wherein the delay threshold is represented as a time interval that the electronic device waits, after a roaming condition occurs as per device implementation, before the electronic device triggers a roaming, and the delay threshold is represented by a set of bits that indicate a minimum and maximum range of delay thresholds that are tolerable at the electronic device.

8. The electronic device of claim 1,
wherein the received STA assistance information at the electronic device comprises a plurality of parameters; and
wherein the plurality of parameters comprises a category value, a STA assistance information action value, an assistance information flag, a hysteresis recommendation, a duration recommendation, and an AP recommendation.

9. The electronic device of claim 8,
wherein the STA assistance information action value indicates a presence or reservation of the STA assistance information;
wherein the assistance information flag is represented by a set of bits that indicate whether one or more packets comprise a hysteresis signal, a duration, and an AP recommendation, a roaming recommendation, or one or more reserved bits;
wherein the hysteresis recommendation indicates a type of hysteresis requirements for the electronic device, comprising one of a no hysteresis, a positive hysteresis, and a negative hysteresis;
wherein the duration recommendation indicates whether action is immediate or occurs after a defined time unit, as recommended by at least one second AP; and
wherein the AP recommendation indicates a list of suitable APs based on one or more preferences indicated by the electronic device.

10. An electronic device comprising:
at least one processor comprising processing circuitry; and
memory storing instructions, wherein at least one processor, individually or collectively, is configured to execute the instructions and to cause the electronic device to:
determine a number of ping-pong handover events between a first access point (AP) and a second AP;
determine whether the number of ping-pong handover events between the first AP and the second AP exceeds a defined threshold;
in response to determining that the number of the ping-pong handover events between the first AP and the second AP exceeds the defined threshold value, trigger a service type event in the electronic device, wherein the service type event comprises one or more of a power saving event, a throughput event, a latency event, and a reliability event; and
in response to triggering the service type event, transmit a station (STA) assistance request to the second AP, wherein the electronic device is previously connected with the first AP, wherein the station (STA) assistance request comprises an indication of a service type event required for the electronic device and a ping-pong flag indicating a requirement for assistance for the electronic device.

11. The electronic device of claim 10, wherein at least one processor, individually or collectively, is configured to cause the electronic device to:
receive a station (STA) assistance information from the second AP, wherein the station (STA) assistance information includes information for managing the required service type for the electronic device.

12. The electronic device of claim 10, wherein the station (STA) assistance response indicates a preferable AP among the plurality of APs for the service type event.

13. The electronic device of claim 10, wherein, prior to detecting the ping-pong handover events between the first AP and the second AP, at least one processor, individually or collectively, is configured to cause the electronic device to:
transmit an association request to the first AP to establish a first communication channel between the electronic device and the first AP,
detect a temporary signal blockage associated with the first established communication channel;
in response to detecting the temporary blockage, identify the second AP to establish a second communication channel between the electronic device and the second AP, wherein a signal quality or signal strength associated with the second established communication channel is superior to the first established communication channel;
transmit a re-association request to the identified second AP,
detect that the temporary blockage has cleared, wherein a signal quality or signal strength associated with the first established communication channel is superior to the second established communication channel; and
in response to detecting that the temporary blockage has cleared, transmit the re-association request along with the indication to the first AP.

14. The electronic device of claim 10, wherein the station (STA) assistance request comprises a plurality of parameters; and
wherein the plurality of parameters comprises a category value, a STA Assistance Message Action value, and a STA assistance request message element.

15. The electronic device of claim 10, wherein the station (STA) assistance information comprises a plurality of parameters,
wherein the plurality of parameters comprises one or more of an identity of element, a length of element, an element ID extension, a control flag, and at least one required service type,
wherein the at least one service type comprises one or more of a throughput preference, a reliability preference, a low latency preference, a power saving preference, and a request assistance flag, a hysteresis signal threshold, and a delay threshold.

16. The electronic device of claim 15, wherein the plurality of parameters comprises an identity of element, a length of element, an element ID extension, a control flag, and at least one required service type, wherein the at least one service type comprises a throughput preference, a reliability preference, a low latency preference, a power saving preference, and a request assistance flag.

17. The electronic device of claim 15, wherein the control flag indicates whether the STA assistance information comprises the throughput preference, the reliability preference, the low latency preference, and the power saving preference;
wherein the throughput preference indicates a type of throughput requirements for the electronic device, comprising one of a low throughput, a medium throughput, and a high throughput, and the throughput represented by one or more bits indicating data rates;
wherein the reliability preference indicates a type of reliability requirements for the electronic device, comprising one of a low reliability, a medium reliability, and a high reliability, and the reliability represented by an error rate tolerance value;
wherein the low latency preference is represented by a value indicating latency tolerance or latency requirement in numbers;
wherein the power saving preference indicates a type of power saving requirements for the electronic device, comprising a low power saving, a medium power saving, and a high power saving, and the power saving preference is represented by a power save category value;
wherein the request assistance and the request assistance flag indicate whether the electronic device requires assistance, and the request assistance and the request assistance flag are represented by a set of bits that indicate whether assistance is needed and a device status;
wherein the hysteresis signal threshold indicates minimum and maximum hysteresis thresholds suitable for the electronic device,
wherein the hysteresis threshold is a signal threshold value that indicates by at least one AP to the electronic device to add an offset to the electronic device (500)-implemented-threshold values for roaming, and the hysteresis signal threshold is represented by a set of bits that indicate a minimum and maximum range of hysteresis thresholds tolerable at the electronic device;
wherein the delay threshold indicates minimum and maximum delays suitable for the electronic device; and
wherein the delay threshold is represented as a time interval that the electronic device waits, after a roaming condition occurs as per device implementation, before the electronic device triggers a roaming, and the delay threshold is represented by a set of bits that indicate a minimum and maximum range of delay thresholds that are tolerable at the electronic device.

18. The electronic device of claim 10,
wherein the STA assistance response comprises a plurality of parameters; and
wherein the plurality of parameters comprises a category value, a STA assistance information action value, and a STA assistance response message element; and
wherein the STA assistance response message element comprises an identity of element, a length of element, an element ID extension, an assistance information flag, a hysteresis recommendation, a duration recommendation, and an AP recommendation.

19. The electronic device of claim 18,
wherein the STA assistance information action value indicates a presence or reservation of the STA assistance information;
wherein the assistance information flag is represented by a set of bits that indicate whether one or more packets comprise a hysteresis signal, a duration, and an AP recommendation, a roaming recommendation, or one or more reserved bits;
wherein the hysteresis recommendation indicates a type of hysteresis requirements for the electronic device, comprising one of a no hysteresis, a positive hysteresis, and a negative hysteresis;
wherein the duration recommendation indicates whether action is immediate or occurs after a defined time units, as recommended by at least one AP; and
wherein the AP recommendation indicates a list of suitable APs based on one or more preferences indicated by the electronic device.

20. A second access point (AP) comprising:
at least one processor comprising processing circuitry; and
memory storing instructions, wherein at least one processor, individually or collectively, is configured to execute the instructions and to cause the second AP to:
receive a re-association request from an electronic device, wherein the electronic device is previously connected with a first AP, wherein the re-association request comprises an indication of a required service type for the electronic device and a flag indicating a requirement for assistance for the electronic device;
generate a recommendation based on the received STA assistance request; and
transmit a station (STA) assistance information to the electronic device to manage the required service type for the electronic device, wherein the STA assistance information comprises the generated recommendation.
